(19) United States
(12) Patent Application Publication
(10) Pub. No.: US 2013/0246164 A1
(43) Pub. Date: Sep. 19, 2013

(54) SYSTEM AND METHOD FOR PREDICTING SPECIFIC MOBILE USER/SPECIFIC SET OF LOCALITIES FOR TARGETING ADVERTISEMENTS.

(71) Applicant: Vimal Kumar Khanna, Mumbai (IN)

(72) Inventor: Vimal Kumar Khanna, Mumbai (IN)

(21) Appl. No.: 13/809,140

(22) PCT Filed: Jul. 11, 2011
(86) PCT No.: PCT/IB2011/001602

§ 371 Date: May 31, 2013

(30) Foreign Application Priority Data
Jul. 9, 2010 (IN) 1977/MUM/2010

(51) Int. Cl. G06Q 30/02

(52) U.S. Cl. CPC G06Q 30/0267
USPC 705/14.45

(57) ABSTRACT

A method for predicting specific mobile users for targeting advertisements, the said method comprising: selecting at least one subset of mobile users subscribing to number of mobile services; creating and initializing subscribers attribute list and subscriber prediction table, based on their demographic details; monitoring the response & behavioral pattern of the mobile users of the subset based on the advertisements sent randomly throughout the day; populating the attribute list and prediction table based on the response information received from the mobile users; formulating a prediction-delivery matrix to identify the preferences of the mobile users for serving advertisements based on the populated attribute list & prediction table; generating a preference information of the mobile users of the subset based on the formulated matrix; extrapolating the generated preference information to the rest of the mobile user subscribers; and mining the mobile users data based on the extrapolated preference information for identifying specific user group for transmitting an advertisement.

### FIELD OF INVENTION

The present invention relates to providing advertisements for mobile devices and similar devices. More particularly, the present invention relates to a method and system for predicting specific mobile users/set of localities for targeting advertisements.

### BACKGROUND ART

Advertisers usually like to target a group of specific audiences in order to ensure that their advertisements are successful. Further, by targeting a group of specific users advertisers can potentially save a large amount of money spent in promotion of the advertisements by identifying right users and presenting such users with advertisements that are particularly applicable to them. In addition, it is beneficial to a user to receive advertisements which are directed towards the user's interests as opposed to receiving advertisements which the user has no interest.

Currently, cellular mobile communication has become widespread all over the world because they provide virtually instantaneous communication.

As the popularization of cellular communication has increased beyond imagination, it has been realized that advertisements through mobile has a greater reach to the users as compared to any other medium. The response rate in this type of advertisement will fetch more revenue to the advertisers.

Conventionally, many attempts were made to provide advertisements to the intended/targeted recipient. Basically, targeted advertisements were selected based on various parameters. The said parameters are his/her age, his/her profile, interests setting, online purchase history, web sites surfed and locations visited and other demographic information.

In spite of all the efforts in prior techniques, the provision for mapping the interest, behavioural pattern of the users of a specific group to the rest of the users of the service provider is weak. Accordingly, it becomes very difficult to identify the interest of all the users of a service provider, due to which there are chances of omitting potential users.

Further, the prior user targeting techniques do not provide a method for determining the right time/preferred time to send advertisements to the users to get a high response.

Furthermore, no conventional advertisement delivery techniques provide for monitoring advertisement delivery for ensuring fairness in advertisements distribution and prevent overloading of some subscribers.

Further, the advertisers have limited budgets for their promotions. Thus, they would like to reach out to the subset of localities that have high preference for their promotions. Further, subscribers currently existing in a locality vary as per the time of the day. The advertiser should broadcast the advertisements at right timeslots in a locality to get higher responses.

Consequently, the existing advertisement targeting and delivery techniques are not very effective in identifying/targeting the intended users and fairly distributing the advertisements of interest to the said users.

Hence, there exists a strong need to provide an effective technique for targeting the right mobile users for better promotion of advertisements.

### OBJECTIVES OF THE INVENTION

The primary objective of the present invention is to provide a system and method for identifying and promoting advertisements to a group of specific users and/or to a specific set of localities for targeting advertisement which addresses at least some of the disadvantages of the conventional advertisement technique.

Another objective of the present invention is to determine a subset of subscribers/subset of localities having a high probability of accepting advertisements in the domain of the advertisements.

Yet another objective of the present invention is to determine the timeslots in which a subscriber/subscribers in a locality have the highest probability of accepting advertisements.

Yet another objective of the present invention is to monitor the advertisement delivery to ensure that the advertisements are fairly distributed among all subscribers/users and no subscriber/user is overloaded with advertisements.

Further objective of the present invention is to display the type and number of advertisements to subscriber/user on a WAP Portal, based on the predicted preference of the subscriber.

One more objective of the present invention is to provide a mechanism to predict the subscribers for high preference for advertisements in new advertising domains, for which no previous records are available.

### SUMMARY OF THE INVENTION

Accordingly, the present invention provides a method for predicting specific mobile users for targeting advertisements, the said method comprising: selecting at least one subset of mobile users subscribing to number of mobile services; creating and initializing subscribers attribute list and subscriber prediction table, based on their demographic details; monitoring the response & behavioural pattern of the mobile users of the subset based on the advertisements sent randomly throughout the day; populating the attribute list and prediction table based on the response information received from the mobile users; formulating a prediction-delivery matrix to identify the preferences of the mobile users for serving advertisements based on the populated attribute list & prediction table; generating a preference information of the mobile users of the subset based on the formulated matrix; extrapolating the generated preference information to the rest of the mobile user subscribers; and mining the mobile users data based on the extrapolated preference information for identifying specific user group for transmitting an advertisement.

The present invention also relates to a method for predicting specific set of localities for targeting broadcast mobile advertisements, the said method comprising: selecting at least one subset of localities, which has residents subscribing to number of mobile services; creating and initializing subscribers attribute list and localities prediction table for this subset of localities, based on the demographic distribution of subscribers in these localities and the VAS services subscribed by them; monitoring the behavioural pattern of the mobile users of the subset of localities and their responses to advertisements broadcast through cell towers of these localities randomly throughout the day, where a broadcast advertisement is received by all the subscribers in the locality; populating the attribute list and prediction table based on the behavioural pattern and advertisement responses received from the mobile users; formulating a prediction-delivery matrix to identify the preferences of the mobile users population in the localities for broadcasting advertisements based on the populated attribute list & prediction table; generating a preference information of the mobile users of the subset of the locality based on the formulated matrix; extrapolating the generated preference information to the rest of the rest of the localities; and mining the mobile users data of the localities based on the extrapolated preference information for identifying specific localities for broadcasting the advertisements.

The present invention further relates to a system for predicting specific mobile user group for targeting advertisements, the said system comprising: a transceiver for transmitting advertisements randomly to a subset of mobile users with specific demographic attributes and subscribing to a number of mobile services; an advertisement allocation unit for scheduling and controlling the timeslots for ads delivery and fair distribution amongst the subset of mobile users; a response monitoring unit for monitoring the response & behavioural pattern of the mobile users of the subset based on the advertisements sent randomly through out the day; a data repository for storing a subscriber attribute list & prediction table; and a prediction server coupled to the said response detection unit and advertisement allocation unit, the said comprising: a means for formulating a prediction-delivery matrix to identify the preferences of the mobile users for serving advertisements based on populating a subscriber attribute list & prediction table; a means for generating a preference information of the mobile users of the subset based on the formulated matrix; a means for extrapolating the generated preference information to the rest of the mobile users; and a means for mining the mobile users data based on the extrapolated preference information for identifying specific user group for transmitting an advertisement.

The present invention furthermore relates to a system for predicting specific set of localities for targeting broadcast mobile advertisements, the said system comprising: a transceiver for transmitting advertisements randomly to at least to a selected subset of localities, which has residents subscribing to number of mobile services having a specific demographic attributes; an advertisement allocation unit for scheduling and controlling the timeslots for ads delivery and fair distribution amongst the subset of mobile users present in the selected locality; a response monitoring unit for monitoring the response & behavioural pattern of the mobile users of the subset of the localities based on the advertisements sent randomly through out the day; a data repository for storing a subscriber attribute list & prediction table; and a prediction server coupled to the said response detection unit and advertisement allocation unit, the said comprising: means for populating the attribute list and prediction table based on the behavioural pattern and advertisement responses received from the mobile users; means for formulating a prediction-delivery matrix to identify the preferences of the mobile users population in the localities for broadcasting advertisements based on the populated attribute list & prediction table; means for generating a preference information of the mobile users of the subset of the locality based on the formulated matrix; means for extrapolating the generated preference information to the rest of the rest of the localities; and mining the mobile users data of the localities based on the extrapolated preference information for identifying specific localities for broadcasting the advertisements.

The present invention also relates to an advertisement delivery server for predicting specific mobile user group for targeting advertisements, the said server comprising: a memory; and a processor operationally coupled to the said memory configured for: selecting at least one subset of mobile users subscribing to number of mobile services; creating and initializing subscribers attribute list and subscriber prediction table, based on their demographic details; monitoring the response & behavioural pattern of the mobile users of the subset based on the advertisements sent randomly throughout the day; populating the attribute list and prediction table based on the feedback received from the mobile users; formulating a prediction-delivery matrix to identify the preferences of the mobile users for serving advertisements based on the populated attribute list & prediction table; mapping the prediction-delivery matrix to the rest of the mobile users; and mining the mobile users data based on the mapping and generating preference summaries for identifying specific user group for transmitting an advertisement.

The present invention further relates an advertisement delivery server for predicting specific set of localities for targeting broadcast mobile advertisements, the said server comprising: a memory; and a processor operationally coupled to the said memory configured for: selecting at least one subset of localities, which has residents subscribing to number of mobile services; creating and initializing subscribers attribute list and localities prediction table for this subset of localities, based on the demographic distribution of subscribers in these localities and the VAS services subscribed by them; monitoring the behavioural pattern of the mobile users of the subset of localities and their responses to advertisements broadcast through cell towers of these localities randomly throughout the day, where a broadcast advertisement is received, by all the subscribers in the locality; populating the attribute list and prediction table based on the behavioural pattern and advertisement responses received from the mobile users; formulating a prediction-delivery matrix to identify the preferences of the mobile users population in the localities for broadcasting advertisements based on the populated attribute list & prediction table; generating a preference information of the mobile users of the subset of the locality based on the formulated matrix; extrapolating the generated preference information to the rest of the rest of the localities; and mining the mobile users data of the localities based on the extrapolated preference information for identifying specific localities for broadcasting the advertisements.

The present invention further relates to a computer program product comprising: program instructions operable to perform a process in a computing device, the process comprising: selecting at least one subset of mobile users subscribing to number of mobile services; creating and initializing subscribers attribute list and subscriber prediction table, based on their demographic details; monitoring the response & behavioural pattern of the mobile users of the subset based on the advertisements sent randomly throughout the day; populating the attribute list and prediction table based on the response information received from the mobile users; formulating a prediction-delivery matrix to identify the preferences of the mobile users for serving advertisements based on the populated attribute list & prediction table; generating a preference information of the mobile users of the subset based on the formulated matrix; extrapolating the generated preference information to the rest of the mobile user subscribers; and mining the mobile users data based on the extrapolated preference information for identifying specific user group for transmitting an advertisement.

The present invention furthermore relates to a computer program product comprising: program instructions operable to perform a process in a computing device, the process comprising: selecting at least one subset of localities, which has residents subscribing to number of mobile services; creating and initializing subscribers attribute list and localities prediction table for this subset of localities, based on the demographic distribution of subscribers in these localities and the VAS services subscribed by them; monitoring the behavioural pattern of the mobile users of the subset of localities and their responses to advertisements broadcast through cell towers of these localities randomly throughout the day, where a broadcast advertisement is received by all the subscribers in the locality; populating the attribute list and prediction table based on the behavioural pattern and advertisement responses received from the mobile users; formulating a prediction-delivery matrix to identify the preferences of the mobile users population in the localities for broadcasting advertisements based on the populated attribute list & prediction table; generating a preference information of the mobile users of the subset of the locality based on the formulated matrix; extrapolating the generated preference information to the rest of the rest of the localities; and mining the mobile users data of the localities based on the extrapolated preference information for identifying specific localities for broadcasting the advertisements.

In the above paragraphs the more important features of the invention has been outlined, in order that the detailed description thereof that follows may be better understood and in order that the present contribution to the art may be better understood and in order that the present contribution to the art may be better appreciated. There are, of course, additional features of the invention that will be described hereinafter and which will form the subject of the claims appended hereto. Those skilled in the art will appreciate that the conception upon which this disclosure is based may readily be utilized as a basis for the designing of other structures for carrying out the several purposes of the invention. It is important therefore that the claims be regarded as including such equivalent constructions as do not depart from the spirit and scope of the invention.

### BRIEF DESCRIPTION OF DRAWINGS

Further aspects and advantages of the present invention will be readily understood from the following detailed description with reference to the accompanying drawings. Reference numerals have been used to refer to identical or similar functionally similar elements. The figures together with a detailed description below, are incorporated in and form part of the specification, and serve to further illustrate the aspects and explain various principles and advantages, in accordance with the present invention wherein:

FIG. 1 illustrates a system in a communication network in accordance with an aspect of the present invention.

FIG. 2 illustrates a prediction and delivery system in accordance with an aspect of the present invention.

FIG. 3 illustrates an allocation unit of the system in accordance with an aspect of the present invention.

FIG. 4 illustrates a monitoring unit of the system in accordance with an aspect of the present invention.

FIG. 5 illustrates a prediction server of the system in accordance with an aspect of the present invention.

FIG. 6 illustrates a transceiver of the system in accordance with an aspect of the present invention.

FIG. 7 illustrates a flow chart an advertisement clicking prediction method in accordance with an aspect of the present invention.

FIG. 8 illustrates a flow chart for a method for monitoring advertisement delivery in accordance with an aspect of the present invention.

FIG. 9 illustrates a flow chart for a method for WAP portal based advertisement delivery in accordance with an aspect of the present invention.

FIG. 10 illustrates a flow chart for a method for advertisement clicking prediction for new Advertising Domains in accordance with an aspect of the present invention.

FIG. 11 illustrates a flow chart for an advertisement click prediction method for static profile in accordance with an aspect of the present invention.

FIG. 12 illustrates a flow chart for an advertisement delivery method for static profile in accordance with an aspect of the present invention.

FIG. 13 illustrates a flow chart for an advertisement click prediction method for dynamic profile in accordance with an aspect of the present invention.

FIG. 14 illustrates a flow chart for an advertisement click prediction method for real time profile in accordance with an aspect of the present invention.

FIG. 15 illustrates a flow chart describing a method for populating advertisement delivery table for real time profile in accordance with an aspect of the present invention.

FIG. 16 illustrates a flow chart for advertisement delivery method for real time profile in accordance with an aspect of the present invention.

Skilled artisans will appreciate that elements in the drawings are illustrated for simplicity and have not necessarily been drawn to scale. For example, the dimensions of some of the elements in the drawings may be exaggerated relative to other elements to help to improve understanding of aspects of the present invention.

### DETAILED DESCRIPTION OF THE PRESENT INVENTION

Accordingly the present invention relates to a method for predicting specific mobile users for targeting advertisements, the said method comprising: selecting at least one subset of mobile users subscribing to number of mobile services; creating and initializing subscribers attribute list and subscriber prediction table, based on their demographic details; monitoring the response & behavioural pattern of the mobile users of the subset based on the advertisements sent randomly throughout the day; populating the attribute list and prediction table based on the response information received from the mobile users; formulating a prediction-delivery matrix to identify the preferences of the mobile users for serving advertisements based on the populated attribute list & prediction table; generating a preference information of the mobile users of the subset based on the formulated matrix; extrapolating the generated preference information to the rest of the mobile user subscribers; and mining the mobile users data based on the extrapolated preference information for identifying specific user group for transmitting an advertisement.

In another aspect of the present invention, wherein said selecting at least one subset of subscribers is based on their subscription to value added services.

In yet another aspect of the present invention, wherein said value added services can be delivered to a mobile terminal through a WAP portal, message services, voice portal, and other modes of mobile VAS delivery.

In still another aspect of the present invention, further comprising predicting the time slots for sending advertisements during which the subscribers have highest probability of accepting advertisements.

In a further aspect of the present invention, further comprising determining a threshold level for transmitting advertisements to each of the subscribers per day.

In a furthermore aspect of the present invention, further comprising scheduling and controlling the delivery of the advertisements to be sent to a subscriber's mobile terminal based on the determination of the time slots and the threshold level for ensuring highest probability of acceptance and fair distribution of advertisements.

In one more aspect of the present invention, further comprising: determining the keywords in the content being displayed on the WAP Portal and determining keywords related to advertisement domains; and mapping the relevant advertisements to the content.

In another aspect of the present invention, further comprising predicting the advertisement acceptance probability of subscribers accessing a WAP portal based on their actions and content being viewed by them; and displaying them the most relevant and right number of advertisements to get a high response.

In yet another aspect of the present invention, further comprising predicting the subscribers for high preference for advertisements in new advertising domains, for which no previous records are available.

The present invention also relates to a method for predicting specific set of localities for targeting broadcast mobile advertisements, the said method comprising: selecting at least one subset of localities, which has residents subscribing to number of mobile services; creating and initializing subscribers attribute list and localities prediction table for this subset of localities, based on the demographic distribution of subscribers in these localities and the VAS services subscribed by them; monitoring the behavioral pattern of the mobile users of the subset of localities and their responses to advertisements broadcast through cell towers of these localities randomly throughout the day, where a broadcast advertisement is received by all the subscribers in the locality; populating the attribute list and prediction table based on the behavioural pattern and advertisement responses received from the mobile users; formulating a prediction-delivery matrix to identify the preferences of the mobile users population in the localities for broadcasting advertisements based on the populated attribute list & prediction table; generating a preference information of the mobile users of the subset of the locality based on the formulated matrix; extrapolating the generated preference information to the rest of the rest of the localities; and mining the mobile users data of the localities based on the extrapolated preference information for identifying specific localities for broadcasting the advertisements.

In another aspect of the present invention, further comprising categorizing the subscribers profiles in the localities into one or more of the following categories: static profile; dynamic profile; and real time profile.

In yet another aspect of the present invention, wherein the said step of categorizing is based on the real time information on the physical movement of the subscribers in a particular locality.

In still another aspect of the present invention, wherein the said step of categorizing is performed by identifying that the subscribers in a particular locality are residents or visitors in the said locality.

In a further aspect of the present invention, wherein said selecting at least one subset of localities is based on subscription of value added services by subscribers in the locality.

In a furthermore aspect of the present invention, wherein said value added services can be delivered to a mobile terminal through broadcast messages.

In one more aspect of the present invention, further comprising predicting the time slots for broadcasting advertisements during which the subscribers in the selected localities have highest probability of accepting advertisements.

In another aspect of the present invention, further comprising determining a threshold level for broadcasting advertisements to each locality per hour of the day.

In yet another aspect of the present invention, further comprising scheduling and controlling the delivery of the advertisements to be broadcast in subset of localities based on the prediction of the time slots ensuring highest probability of acceptance and at the threshold level ensuring fair distribution of advertisements.

The present invention further relates to a system for predicting specific mobile user group for targeting advertisements, the said system comprising: a transceiver for transmitting advertisements randomly to a subset of mobile users with specific demographic attributes and subscribing to a number of mobile services; an advertisement allocation unit for scheduling and controlling the timeslots for ads delivery and fair distribution amongst the subset of mobile users; a response monitoring unit for monitoring the response & behavioural pattern of the mobile users of the subset based on the advertisements sent randomly through out the day; a data repository for storing a subscriber attribute list & prediction table; and a prediction server coupled to the said response detection unit and advertisement allocation unit, the said comprising: a means for formulating a prediction-delivery matrix to identify the preferences of the mobile users for serving advertisements based on populating a subscriber attribute list & prediction table; a means for generating a preference information of the mobile users of the subset based on the formulated matrix; a means for extrapolating the generated preference information to the rest of the mobile users; and a means for mining the mobile users data based on the extrapolated preference information for identifying specific user group for transmitting an advertisement.

In another aspect of the present invention, wherein the said response monitoring unit comprising: a receiver circuit operable to receive response information of a user for a particular advertisements.

In yet another aspect of the present invention, wherein the said advertisement allocation unit comprising: a memory for storing the received response information; a threshold level generator for determining the number of advertisements to be sent to the mobile users based on the received response information; and an advertisement timing controller for predicting the time slots for sending advertisements during which the subscribers have highest probability of accepting advertisements and controlling the transmission of the advertisements.

In still another aspect of the present invention, wherein the said prediction server comprising: an interface unit; a memory; an extraction circuit configured to compute the response information received; and a processing circuit for classifying the reaction of a mobile user to the advertisement based on the response information by creating prediction-delivery matrix, generating preference summaries and extrapolating the generated preference summaries of the mobile users of the subset to the rest of the subscribers for identifying specific user group for transmitting an advertisement.

In a further aspect of the present invention, further comprising: advertisement broadcasting circuit for broadcasting the selected advertisements to the specific localities.

In a furthermore aspect of the present invention, wherein the said prediction server being configured to select at least one subset of mobile users subscribing to number of mobile services.

In one more aspect of the present invention, wherein the said prediction server being configured to select at least one subset of subscribers based on their subscription to value added services.

In another aspect of the present, invention, wherein the said transmitter being configured to transmit the said value added services to a mobile terminal through a WAP portal, message services, voice portal, and other modes of mobile VAS delivery.

In yet another aspect of the present invention, wherein the said prediction server is further configured to: determine the keywords in the content being displayed on the WAP Portal and determining keywords related to, advertisement domains; and mapping the relevant advertisements to the content.

In still another aspect of the present invention, wherein the said prediction server is further configured to: predicting the advertisement acceptance probability of subscribers accessing a WAP portal based on their actions and content being viewed by them; and displaying them the most relevant and right number of advertisements to get a high response.

In a furthermore aspect of the present invention, wherein the said prediction server is further configured to predict the subscribers for high preference for advertisements in new advertising domains, for which no previous records are available.

The present invention furthermore relates to a system for predicting specific set of localities for targeting broadcast mobile advertisements, the said system comprising: a transceiver for transmitting advertisements randomly to at least to a selected subset of localities, which has residents subscribing to number of mobile services having a specific demographic attributes; an advertisement allocation unit for scheduling and controlling the timeslots for ads delivery and fair distribution amongst the subset of mobile users present in the selected locality; a response monitoring unit for monitoring the response & behavioural pattern of the mobile users of the subset of the localities based on the advertisements sent randomly through out the day; a data repository for storing a subscriber attribute list & prediction table; and a prediction server coupled to the said response detection unit and advertisement allocation unit, the said comprising: means for populating the attribute list and prediction table based on the behavioural pattern and advertisement responses received from the mobile users; means for formulating a prediction-delivery matrix to identify the preferences of the mobile users population in the localities for broadcasting advertisements based on the populated attribute list & prediction table; means for generating a preference information of the mobile users of the subset of the locality based on the formulated matrix; means for extrapolating the generated preference information to the rest of the rest of the localities; and mining the mobile users data of the localities based on the extrapolated preference information for identifying specific localities for broadcasting the advertisements.

In another aspect of the present invention, wherein the said response monitoring unit comprising: a receiver circuit operable to receive response information of the mobile user of a locality for a particular advertisement.

In yet another aspect of the present invention, wherein the said advertisement allocation unit comprising: a memory for storing the received response information; a threshold level generator for determining the number of advertisements to be sent to the mobile users of the subset of the localities based on the received response information; and an advertisement timing controller for predicting the time slots for sending advertisements during which the subscribers of the subset of the localities have highest probability of accepting advertisements and controlling the transmission of the advertisements.

In still another aspect of the present invention, wherein the said prediction server comprising: an interface unit; a memory; an extraction circuit configured to compute the response information received; and a processing circuit for classifying the reaction of a mobile user of the subset of the localities to the advertisement based on the response information by creating prediction-delivery matrix, generating preference summaries and extrapolating the generated preference summaries of the mobile users of the subset of the localities to the rest of the localities for identifying specific user group for transmitting an advertisement.

In a further aspect of the present invention, further comprising: advertisement broadcasting circuit for broadcasting the selected advertisements to the specific localities.

In a furthermore aspect of the present invention, the said prediction server configured to categorize the subscribers profiles in the localities into one or more of the following categories: static profile; dynamic profile; and real time profile.

In one or more aspect of the present invention, the said prediction server is configured to categorize based on the real time information on the physical movement of the subscribers in a particular locality.

In another aspect of the present invention, the said prediction server performs the categorization by identifying that the subscribers in a particular locality are residents or visitors in the said locality.

In yet another aspect of the present invention, wherein the prediction server selects at least one subset of localities, based on subscription of value added services by subscribers in the locality.

In still another aspect of the present invention, wherein said broadcasting circuit broadcast the value added services to a mobile terminal.

The present invention also relates to an advertisement delivery server for predicting specific mobile user group for targeting advertisements, the said server comprising: a memory; and a processor operationally coupled to the said memory configured for: selecting at least one subset of mobile users subscribing to number of mobile services; creating and initializing subscribers attribute list and subscriber prediction table, based on their demographic details; monitoring the response & behavioral pattern of the mobile users of the subset based on the advertisements sent randomly throughout the day; populating the attribute list and prediction table based on the feedback received from the mobile users; formulating a prediction-delivery matrix to identify the preferences of the mobile users for serving advertisements based on the populated attribute list & prediction table; mapping the prediction-delivery matrix to the rest of the mobile users; and mining the mobile users data based on the mapping and generating preference summaries for identifying specific user group for transmitting an advertisement.

The present invention further relates to an advertisement delivery server for predicting specific set of localities for targeting broadcast mobile advertisements, the said server comprising: a memory; and a processor operationally coupled to the said memory configured for: selecting at least one subset of localities, which has residents subscribing to number of mobile services; creating and initializing subscribers attribute list and localities prediction table for this subset of localities, based on the demographic distribution of subscribers in these localities and the VAS services subscribed by them; monitoring the behavioural pattern of the mobile users of the subset of localities and their responses to advertisements broadcast through cell towers of these localities randomly throughout the day, where a broadcast advertisement is received by all the subscribers in the locality; populating the attribute list and prediction table based on the behavioural pattern and advertisement responses received from the mobile users; formulating a prediction-delivery matrix to identify the preferences of the mobile users population in the localities for broadcasting advertisements based on the populated attribute list & prediction table; generating a preference information of the mobile users of the subset of the locality based on the formulated matrix; extrapolating the generated preference information to the rest of the rest of the localities; and mining the mobile users data of the localities based on the extrapolated preference information for identifying specific localities for broadcasting the advertisements.

### DETAILED DESCRIPTION OF THE TABLES

### I. We Shall Now Describe Here Below Tables for Illustrating and Exemplifying The Method for Predicting Specific Mobile Users for Targeting Advertisements.

TABLE 1
Global Variables

| Global Variable | Value |
|---|---|
| ObservationPeriod (days) | 15 |
| StartTime (24 hour clock) | 8 |
| EndTime (24 hour clock) | 19 |
| FractionAds | 0.7 |
| MaxAdsPerDay | 5 |
| MAXDisplayAdvertisements | 3 |
| MINDisplayAdvertisements | 1 |
| SelectedDays | 3 |

TABLE 2
Subscribers Attributes List

| | | | | | | | TimeToClickAttributes | | | Max |
|---|---|---|---|---|---|---|---|---|---|---|
| | | | | ClickAttributes | | | News | % News | | Ads |
| Phone | GeneralAttributes | | | Stock | News | | Access | Access | | Per |
| No. | Age | Gender | . . . | Quote | Access | . . . | Time#8 | Time#8 | . . . | Day |
| X | 50 | Male | | Yes | 60 | | 1 | 25 | | 5 |

TABLE 3
Subscribers Prediction Table

| | AdDomain#k | | | | | | PreferredHours | | | ClickHours | | | Max | Day |
|---|---|---|---|---|---|---|---|---|---|---|---|---|---|---|
| Phone | | Ads | Ads | | Past | Time | Hour | Hour | | Hour | Hour | | Click | Ads |
| No. | Flag | Sent | Click | Click % | Click % | Opted | #1 | #2 | . . . | #1 | #2 | . . . | Hour | Sent |
| X | Known | 20 | 3 | 15 | 10 | Yes | 8 | 0 | | 10 | 8 | | 10 | 4 |
| W | Predicted | 0 | 0 | 10 | 0 | No | 0 | 0 | | 16 | 8 | | 0 | 5 |

TABLE 4
Advertisers' Start and End times for sending promotions

| | AdvStartTime | AdvEndTime |
|---|---|---|
| Advertiser | (Hour) | (Hour) |
| Advertiser1 | 10 | 17 |
| Advertiser2 | 8 | 17 |
| . . . | | |
| AdvertiserN | 12 | 19 |

TABLE 5
Advertisement Delivery Table

| Slab | Slab | | |
|---|---|---|---|
| Number | (as %) | SlabCount | DaySlabCount |
| 1 | 95 | 5 | 0 |
| 2 | 90 | 30 | 0 |
| . . . | . . . | | |
| 19 | 5 | 100 | 80 |
| 20 | 0 | 200 | 200 |

TABLE 6
Subscriber Credentials Table

| LoginId | Phone No. |
|---|---|
| User5 | X |
| User232 | V |

TABLE 7
Subscriber Advertising Domains Preference Table

| Phone No. | AdDomain#1 | AdDomain#2 | . . . | AdDomain#N |
|---|---|---|---|---|
| X | IT | CricketScore | | News 20 |
| U | Finance | IPO | | Football |

TABLE 8
Content - Advertising Domain Mapping Table

| ContentURL | AdDomain#1 | AdDomain#2 | . . . | AdDornain#M |
|---|---|---|---|---|
| www.xx.yy/ | IPO | IT | | Finance |
| content1 | | | | |
| www.xx.yy/ | CricketScore | Sports | | News |
| content2 | | | | |

TABLE 9
Hierarchy of Advertising Domains

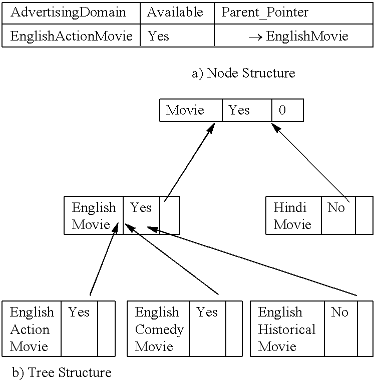

TABLE 10
Extended Subscribers Prediction Table

| | AdDomain#1 | | | | AdDomain#2 | | | | | | | | | |
|---|---|---|---|---|---|---|---|---|---|---|---|---|---|---|
| | (EnglishActionMovie) | | | | (EnglishComedyMovie) | | | | AdDomain#10 | | | AdDomain#100 | | |
| | | Ads | Ads | | | Ads | Ads | | (EnglishMovie) | | | (Movie) | | |
| Phone No. | Flag | Sent | Click | . . . | Flag | Sent | Click | . . . | Flag | . . . | Click % | Flag | . . . | Click % |
| X | Known | 15 | 5 | . . . | Known | 5 | 5 | . . . | Known | . . . | 50 | Known | . . . | 50 |
| 9812342222 | Predicted | 0 | 0 | . . . | Known | 10 | 2 | . . . | Known | . . . | 20 | Known | . . . | 20 |
| 9812343333 | Predicted | 0 | 0 | . . . | Predicted | 0 | 0 | . . . | Predicted | . . . | 5 | Predicted | . . . | 5 |

We here below describe the above mentioned tables in detail.

### I. Global Variables

The Content Service Provider initially populates a set of Global Variables given in Table 1, as described below—

ObservationPeriod—Duration of past period for which subscribers actions are observed for classification of subscribers.

StartTime—The earliest start time in the day for sending advertisements to subscribers. A 24 hour clock is used—from Hour #1 to Hour #24. The start times of sending advertisements of all the advertisers registered with the Content Service Provider are considered, and the earliest one of them is denoted as “StartTime”.

EndTime—The latest end time in the day among all the advertisers for sending advertisements.

FractionAds—This parameter defines the fraction of the advertisements that are sent to the subscribers with high probability of clicking the advertisements. The rest of the advertisements are sent randomly to subscribers, as would be explained in description of Flow Chart 2.

MaxAdsPerDay—For SMS/Voicecall based advertisement delivery, a subscriber is not overloaded by advertisement by limiting the maximum number of advertisements to be sent to a subscriber per day to “MaxAdsPerDay”.

MAXDisplayAdvertisements—The subscribers are displayed a maximum of “MAXDisplayAdvertisements” advertisements on the WAP Portal at any time, so as not to clutter the portal.

MINDisplayAdvertisements—The subscribers are displayed a minimum of “MINDisplayAdvertisements” advertisements on the WAP Portal at any time.

SelectedDays—The time a subscriber clicks on an advertisement in a day depends on the activities performed by the subscriber on that day. A sample subset of days equaling a count of “SelectedDays” is chosen in the “ObservationPeriod” and the activities of the subscriber are observed over these days to predict the time to click behaviour.

### II. Per Subscriber Variables:

The information related to each subscriber is stored in a single “Subscribers Table”, which is being shown as two tables in this text to simplify description—“Table 2: Subscribers Attributes List” and “Table 3: Subscribers Prediction Table”. These tables are indexed by the subscriber mobile “Phone No.” attribute.

### III. Subscribers Attributes List:

The subscriber related attributes are divided in three categories and stored in Table 2—

a) General Attributes: The subscriber shares his/her demographics and other details with the Content Service Provider at the time of subscribing to the service. The list of attributes includes (but is not limited to)—Age, Gender, Locality, Occupation, etc.

b) Click Attributes: The attributes used to predict the probability of a subscriber clicking on advertisements are listed as “ClickAttributes”.

The Content Service Provider offers a number of VAS elements to the subscribers. The list of VAS elements includes (but is not limited to)—News, Finance News, Stock Quote, Cricket Score, Horoscope, etc. Unique SMS Short Codes are assigned to each VAS element.

The Content Service Provider also offers information service on specific topics through Voice Portal. Again, unique Short Codes/Phone Numbers are assigned to each information service.

The subscriber access VAS content, or receives information from the Voice Portals, in the following ways—

### i) VAS Subscription Attributes

The subscriber permanently subscribes to a VAS element. The subscriber then receives messages related to that content at regular intervals, say, twice a day.

The Table contains attributes for each VAS element subscription and marks the status of subscriber subscription to that element as “Yes” or “No”. For example, if subscriber subscribes to “StockQuote” VAS element, the attribute would be marked as “Yes”. The subscriber would then receive SMS massages with Stock Quotations at regular intervals.

### ii) VAS Access Attributes

The subscriber may decide not to permanently subscribe to a VAS element but to receive its content at will. In this case the subscriber would send SMS message to the Short Code of the VAS element and would receive content in the response SMS message.

The Table contains attributes for total number of accesses made to each VAS element. For example, subscriber may send SMS messages to “News” VAS element to receive current news content. The Table has a corresponding attribute “NewsAccess”. The total count of SMS messages sent by subscriber to “News” VAS element Short Code over the “ObservationPeriod” is counted and stored against this attribute.

In case of subscriber accessing information through Voice Portal Short Code/Phone Number, the total time spent on these voice calls over the “ObservationPeriod” is stored as corresponding attribute value. Similarly, if a subscriber is accessing the WAP Content Portal of the Content Service Provider, total time spent on the portal for specific contents is considered another attribute.

### c) Time To Click Attributes:

The attributes used to predict the probable timeslots of a subscriber for clicking on advertisements are listed as “TimeToClickAttributes”. The list includes (but is not limited to) attributes described below.

The Table contains attributes for average (over the “ObservationPeriod”) number of accesses made to each VAS element in each hour of a day. For example, subscriber may, on an average, send 1 SMS message to “News” VAS element (to receive current news content) in the timeslot 8 AM to 9 AM. The Table has corresponding attribute “NewsAccessTime#8” and value 1 is stored against it.

Another corresponding attribute “% NewsAccessTime#8” stores the fraction (percentage) of accesses made in this hour as compared to average number of accessed made per day. For example, the Table shows that total number of accesses made to “News” VAS element in an “ObservationPeriod” of 15 days was 60 (Click Attribute “NewsAccess”), resulting average number of 4 accesses per day. Since “NewsAccessTime#8” has value 1, “% NewsAccessTime#8” is calculated and stored as 25%.

Further, the sum of accesses made to all VAS elements in that hour and the representation of its fraction over the day are also used as attributes.

In case of subscriber accessing information through Voice Portal Short Code/Phone Number, the average time spent on these voice calls during the hour and its representation as percentage of total time spent over the day, are stored as the corresponding attributes.

### d) Max Ads Per Day

The subscriber has the option to specify the maximum number of advertisements (including all modes of delivery)—“MaxAdsPerDay”, he/she wants to receive in a day. If subscriber does not specify this value, the global variable for this purpose (Section 3.1) is copied in this attribute.

### IV. Subscribers Prediction Table:

This table lists the parameters related to prediction of a subscriber clicking the advertisement and the time of clicking the advertisement. The subscribers have different preference for advertisements in different domains (like, IPO Domain, Cricket Score Domain, etc.). Hence, separate prediction is made for each domain of advertisement in “Subscribers Prediction Table”. The first 5 parameters below are identified separately for each Advertising Domain. If there are N domains of advertisements then there are N entries for each of the 5 parameters, “AdDomain#k”, k=1 to N.

All the other attributes in the Table are not Advertisement Domain specific, but are for all the advertisements being sent to the subscriber.

The table parameters are described below—

Flag (Known/Predicted)—A subset of subscribers are sent advertisements (in the selected Advertising Domain) in the “ObservationPeriod” and their responses are noted. The Flag for theses subscribers is marked as “Known” and their data is used for Classification. Rest of the subscribers are marked with “Predicted” flag, and their responses are predicted from the results of the Classification.

AdsSent—Total number of advertisements sent to a “Known” subscriber is counted in the “ObservationPeriod” and stored in this attribute.

AdsClick—Total number of advertisements clicked by the above subscriber in the “ObservationPeriod”.

Click %—The attribute tells the probability of a subscriber clicking on an advertisement.
For a “Known” subscriber the attribute contains fraction of advertisements clicked by the subscriber during the “ObservationPeriod”=(AdsClick/AdsSent)*100.
For a “Predicted” subscriber, this attribute value is populated by the “Click Prediction” methodology.

PastClick %—The percentage of advertisements clicked by the subscriber in the “ObservationPeriod” immediately preceding the current “ObservationPeriod”.

TimeOpted (Yes/No)—A subscriber may preselect specific hours in the day when he/she wants to receive the advertisements. The “TimeOpted” flag would be set as “Yes” for such subscribers. The subscriber is then sent advertisements in these hours instead of the hours predicted by the “Time to Click” methodology (except under sonic conditions, mentioned later). The “TimeOpted” flag is set as “No” for a subscriber who has not given any time preference. The subscriber is then sent advertisements in the hours predicted by the “Time to Click” methodology.

PreferredHours—The list of hours preferred by a subscriber to receive an advertisement, if the “TimeOpted” attribute is “Yes”. The preferred hours of the day (in 24-hour Clock format) opted by the subscriber are listed in the initial entries of this attribute list and the remaining entries are filled with 0. E.g., if subscriber selects preferred hours as 11 AM and 4 PM, “Hour#1” value would be set as 11 and “Hour#2” value as 16, all the rest entries being 0. The example of a subscriber opting for only 8 AM as preferred time is shown in the Table.

ClickHours—The attribute list tells the probability of a subscriber clicking on an advertisement in specific hours of the day—
For a “Known” subscriber the attribute contains the hours in which a subscriber clicks the advertisements. The listed is sorted in descending order as per the count of clicking in each hour. For example, if a subscriber clicks 60% of times at 10 AM and 40% of times at 8 AM, the first entry “Hour#1” value would be set as 10 followed by “Hour#2” as 8.
For a “Predicted” subscriber, this attribute list is populated by the “Time to Click” Prediction methodology. The list contains the predicted hours in which a subscriber will click an advertisement in descending sorted order.

It should be noted that this attribute list is populated for all the subscribers, included the ones who have their “TimeOpted” attribute as “Yes”. It may happen that the Advertiser does not send advertisements in the preferred hours of the subscriber (i.e., the Advertiser's “Start Time” to “End Time” for sending advertisements may not include the preferred hour of the subscriber). Then these “Click Hours” are used for sending the advertisement to that subscriber.

MaxClickHour—This attribute is populated for “Known” subscribers and stores the value of the hour in which a subscriber clicks the advertisement maximum times. In case of multiple such hours having same value, the winner is chosen randomly.

DayAdsSent—The total number of advertisements sent to subscriber till the current time in the given day are stored in this attribute. The maximum value of this attribute is limited to “MaxAdsPerDay” by our advertisement delivery methodology.

### V. Per Advertiser Variables:

The set of variables specific to each Advertiser are given in Table 4, as described below—

AdvStartTime—Each advertiser has its own start time in the day for sending the advertisements. The attribute stores the start time for each advertiser. The example of “Advertiser1” with “AdvStartTime” as 10 AM is shown.

AdvEndTime—The last hour in the day after which the advertiser does not send any more advertisements. The example of “ ” Advertiser1 with “AdvEndTime” as 5 PM is shown in the Table.

It should be noted that for each advertiser “J”, the following criteria must be met—

(AdvStartTime_{AdvertiserJ}>=StartTime) & (AdvEndTime_{AdvertiserJ}<=EndTime)

### VI. Advertisement Delivery Related Variables

The count of subscribers in specific ranges of percentage probability of clicking advertisements is given in Table 5. The Table is populated based on the values of “Click %” in the “Subscribers Prediction Table”.

Slab—The percentage probability of clicking advertisements is divided in fixed number of slab. The “Slab” attribute stores the lower bound of each slab in % terms. E.g., if slab size is chosen as 5%, the “Slab” attribute contains list of values starting from 0% to 95% in slabs of 5% each.

SlabCount—The attribute contains the number of subscribers with “Click %” falling within the given slab range. E.g., if there are 30 subscribers with “Click %” between 90% and 95%, the “SlabCount” against “Slab” value of 90 would be shown as 30.

DaySlabCount—The attribute contains the number of subscribers for that slab range at the current time on the given day. Its value for a slab is initially set to “SlabCount” for the slab at the start of the day. As the day progresses and “m” number of subscribers in the slab have been sent advertisements equaling “MaxAdsPerDay”, the “DaySlabCount” value at that time instance is determined as—

DaySlabCount=SlabCount−m

### VII. Subscriber Credentials

Subscribers access the WAP Portal of the Content Service Provider for accessing the content of their interest. A unique Login Account is created for each subscriber for this purpose. The subscriber logs into the portal using his Login Id. Table 6 contains the mapping of Login Id. to Phone number of subscribers—

LoginId—The unique Login Id for the subscriber.

Phone No.—The phone number of the subscriber.

### VIII. Subscriber Advertising Domains Preference

“Subscribers Prediction Table” stores the “Click %” of advertisements sent to subscribers in different Advertising Domains. A subscriber has higher “Click %” for some domains and lesser for others. E.g., a subscriber may have higher interest in IT related promotions and lesser interest in Cricket related promotions. Table 7 stores the preference (determined through “Click %”) of subscribers for different Advertising Domains in descending order—

Phone No.—Subscriber Phone number.

AdDomain#k—Names of the Advertising Domains in descending order of preference.

### IX. Content—Advertising Domain Mapping

Each content item displayed on the WAP Portal has a number of keywords. A standard keyword search method (not shown in techniques) is run to determine all keywords in the content being displayed on the portal and determine the Advertising Domains related to the keywords. For example, if the content is a news item on an IT company filing for an IPO, the related Advertising Domains would be “IT”, “IPO”, “Finance”, etc. Advertisements from these domains will then be displayed when a subscriber clicks on this content. Table 8 shows the entries for each content item—

ContentURL—The URL of the content.

AdDomain#k—List of Advertising Domains relevant to the content.

### X. Hierarchy of Advertising Domains:

The Content Service Provider may get advertisements to be sent to subscribers which belong to an advertising domain for which it has not sent any advertisements earlier. In such a case, the “Click Prediction” for the domain is unknown. However, the domain could belong to a higher level abstract domain. E.g., an “English Historical Movie” promotion also belongs to a higher level abstract domain “English Movie”. If “Click Predictions” of other genre of movies under “English Movie” abstract domain are known, then we can predict the preference of a subscriber for “English Movies” in general, and use that prediction for “English Historical Movie”. Such hierarchies of domains are created for the range of advertisement domains available, as shown in Table 9. The domains are stored in a Hierarchical Tree form and elements of each node in the tree are as below—

AdverisingDomain—The name of the advertising domain, e.g., “EnglishActionMovie”

Available—If Click Prediction for this domain is available then this Flag is set as “Yes”, else “No”.

Parent_Pointer—Pointer to the next (higher) level abstract domain in the tree for the current Advertising Domain.

### XI. Extended Subscribers Prediction Table:

The “Subscribers Prediction Table” is extended by adding entries for the abstract Advertising Domains, created as above. The “Click %” for the abstract Advertising Domain is calculated from the sum of “AdsSent” and “AdsClick” of children nodes. The extended Table 10 has additional entries for abstract Advertising Domains with the following elements—

Flag—The flag is set to “Known” if any child of this node has this flag set as “Known”.

AdsSent—Sum of advertisements sent to “Known” children nodes.

AdsClick—Sum of advertisements clicked by the subscriber.

Click %, PastClick %—As described earlier in Section 3.2.2.

II. We shall now describe here below tables for illustrating and exemplifying the Method for Predicting Specific Localities for Targeting Advertisements

| Global Variable | Value |
|---|---|
| ObservationPeriod (days) | 15 |
| StartTime (24 hour clock) | 8 |
| EndTime (24 hour clock) | 19 |
| MaxAdsPerHour | 10 |
| SyncPeriod (Minutes) | 20 |

TABLE 1
Global Variables

| | GeneralAttributes | | | | | VASAttributes | | |
|---|---|---|---|---|---|---|---|---|
| Phone | | | | Occu- | | Stock | | |
| No. | Locality | Age | Gender | pation | . . . | Quote | News | . . . |
| X | “A” | 49 | Male | Engineer | | 0.5 | 1 | |
| Y | “B” | 20 | Female | Student | | 0 | 1 | |
| Z | “A” | 40 | Male | Accoun- | | 1 | 0.5 | |
| | | | | tant | | | | |

TABLE 2
Subscribers Attributes List

| | | Ads | Ads | Click |
|---|---|---|---|---|
| Hour | Flag | Sent | Click | Count |
| 8 | Known | 20 | 60 | 3 |
| 9 | Predicted | 0 | 0 | 0 |
| . . . | | | | |
| 19 | Known | 5 | 100 | 20 |

TABLE 3
Locality Click Table for “A”” for Advertising Domain “Sports”

| | | Ads | Ads | Click |
|---|---|---|---|---|
| Hour | Flag | Sent | Click | Count |
| 8 | Predicted | 0 | 0 | 0 |
| 9 | Predicted | 0 | 0 | 0 |
| . . . | | | | |
| 19 | Known | 10 | 60 | 6 |

TABLE 4
Locality Click Table for “B” for Advertising Domain “Sports”

| | | GeneralAttributes | | | VASAttributes | | Click |
|---|---|---|---|---|---|---|---|
| Locality | Flag | Count | Age 40-49 | . . . | News | . . . | Count |
| “A” | Known | 20000 | 5000 | | 10000 | | 3 |
| “B” | Predicted | 25000 | 2500 | | 8000 | | 6 |
| . . . | | | | | | | |

TABLE 5
Localities Prediction Table for Advertising Domain “Sports” at 8 AM
(Static Profiles Case)

| Locality | Flag | Hour | ClickCount | TotalAds |
|---|---|---|---|---|
| “B” | Predicted | 8 | 6 | 8 |
| “B” | Known | 16 | 5 | |
| . . . | | | | |
| “A” | Known | 8 | 3 | 0 |

TABLE 6
Advertisement Delivery Table for Advertising Domain “Sports”
(Static Profiles case)

| | Residential |
|---|---|
| Phone No. | Status |
| X | Resident |
| Y | Visitor |
| Z | Resident |

TABLE 7
Subscribers in the Locality “A” at 8 AM (Dynamic Profiles Case)

| | | | RESIDENTS | | | | | VISITORS | | | | |
|---|---|---|---|---|---|---|---|---|---|---|---|---|
| | | | General | | | | | General | | | | |
| | | | Attributes | | | VAS | | Attributes | | | VAS | |
| | | | | | Age | Attributes | | | | Age | Attributes | Click |
| Locality | Flag | TOTAL | Count | % | 40-49 | News | . . . | Count | % | 40-49 | . . . | Count |
| “A” | Known | 25000 | 15000 | 60 | 2500 | 10000 | | 10000 | 40 | 1250 | | 5 |
| “B” | Predicted | 20000 | 10000 | 50 | 4000 | 8000 | | 10000 | 50 | 1000 | | 4 |
| . . . | | | | | | | | | | | | |

TABLE 8
Localities Prediction Table for Advertising Domain “Sports” at 8 AM
(Dynamic Profiles Case)

| | | | RESIDENTS | | | | | VISITORS | | | | |
|---|---|---|---|---|---|---|---|---|---|---|---|---|
| | | | GeneralAttributes | | | VAS | | GeneralAttributes | | | VAS | |
| | | | | | Age | Attributes | | | | Age | Attributes | Click |
| Locality | Flag | TOTAL | Count | % | 40-49 | News | . . . | Count | % | 40-49 | . . . | Count |
| “A” | Predicted | 25000 | 15000 | 60 | 1250 | 8000 | | 10000 | 40 | 2500 | | 12 |
| “B” | Predicted | 20000 | 10000 | 50 | 2000 | 7000 | | 10000 | 50 | 500 | | 8 |

TABLE 9
Localities Prediction Table for Advertising Domain “Sports”
for Current Hour (Real Time Profiles Case)

| | Click | Total |
|---|---|---|
| Locality | Count | Ads |
| “A” | 12 | 10 |
| . . . | | |
| “B” | 8 | 2 |

Table 10: Advertisement Delivery Table for Advertising Domain “Sports” for Current Hour (Real Time Profiles Case)

We here below describe the above mentioned tables in detail.

### Global Variables

The Content Service Provider initially populates a set of Global Variables given in Table 1, as described below—

ObservationPeriod—Duration of past period for which subscribers' actions and advertisements clicked in localities are observed for making Classification (prediction).

StartTime—The earliest hour in the day for broadcasting advertisements to localities. A 24 hour clock is used—Hour #1 to Hour #24.

EndTime—The latest hour in the day for broadcasting advertisements.

MaxAdsPerHour—Subscribers are not overloaded by advertisements by limiting the maximum number of advertisements to be broadcast in a locality per hour to “MaxAdsPerHour”.

SyncPeriod—The mobile phone application communicates its location coordinates to Content Service Provider server application every “SyncPeriod” minutes. We are considering a “SyncPeriod” of 20 minutes with the mobile phone synchronising its location coordinates three times in an hour.

### 2 Localities Specific Variables

We would now discuss contents of tables created specific to localities and their subscribers.

### 2.1 Subscribers Attributes List

The information related to each subscriber is stored in “Table 2: Subscribers Attributes List” against the “Phone No.” of the subscriber. The subscriber related attributes are divided in two categories—

### 2.1.1 GeneralAttributes

The subscriber shares his/her demographics and other details with the Content Service Provider at the time of subscribing to the service. The “GeneralAttributes” list of attributes includes (but is not limited to)—Locality, Age, Gender, Occupation, etc.

### 2.1.2 VASAttributes

The Content Service Provider offers a number of VAS Elements to the subscribers to be broadcast on their Idle Screen Display. The list of VAS elements includes (but is not limited to)—News, Finance News, Stock Quote, Cricket Score, Horoscope, etc.

The subscriber can subscribe or unsubscribe to any VAS Element at anytime and Content Service Provider becomes aware of these actions.

The “VASAttributes” contains attributes for each VAS Element populated with the fraction of period in the “ObservationPeriod” for which the subscriber has been subscribed to the element. For example, if subscriber has kept subscribed to “News” VAS Element for the complete “ObservationPeriod”, the attribute value would be 1. If the subscriber has subscribed to “StockQuote” VAS Element only mid-way through the “ObservationPeriod”, the attribute value would be 0.5.

### 2.2 Locality Click Table

This table lists details of total advertisements sent to a locality and number of subscribers clicking these advertisements at different hours. The subscribers have different preference for advertisements in different domains (like, IPO Domain, Cricket Score Domain, etc.). Hence, separate “Locality Click Table” is made for each domain of advertisement. For example, Table 3 is for locality ““A”” for Advertising Domain “Sports” and Table 4 is for locality ““B”” for Advertising Domain “Sports”.

Separate row is created in the Table for each hour of the day between “StartTime” and “EndTime”.

The table parameters are described below—

Flag—A subset of localities are broadcast advertisements (in the selected Advertising Domain) at random hours in the “ObservationPeriod” and their responses are noted. For a given locality, the Flag for a given hour is marked as “Known” if advertisements have been broadcast in that hour. This data is used for Classification. Rest of the hours are marked with “Predicted” flag, and their responses are predicted from the results of the Classification.

AdsSent—Total number of advertisements broadcast to a locality in the given hour is counted in the “ObservationPeriod” and stored in this attribute.

AdsClick—Total number of subscribers in the locality clicking on the above advertisements in the “ObservationPeriod” is stored in this attribute. For example, if total 20 advertisements were broadcast to the locality and each advertisement was clicked by 3 subscribers, the “AdsClick” value would be 60.

ClickCount—The attribute tells the average number of subscribers in a locality clicking on an advertisement—
For a “Known” Flag hour entry, the attribute contains average count of subscribers clicking during the “ObservationPeriod”=(AdsClick/AdsSent).
For example, if 5 advertisements were broadcast and a total of 100 subscribers clicked advertisements in the “ObservationPeriod”, “ClickCount” would be 20.
For a “Predicted” hour entry, this attribute value is marked as 0.

### 2.3 Localities Prediction Table (Static Profiles Case)

The profiles of subscribers in different localities and their advertisement clicking habits are stored in “Localities Prediction Table”. Separate Table is built per hour for each Advertising Domain. For example, Table 5 shows “Localities Prediction Table” for Advertising Domain “Sports” at 8 AM.

The table is built by extracting attributes from “Subscribers Attributes List” and “Locality Click Table”. The attributes are described as below—

### 2.3.1 Flag

The attribute has same connotation as in “Locality Click Table”. For the locality entry in a given row of the “Localities Prediction Table”, the “Locality Click Table” for that locality is searched for the value of the “Flag” for the hour entry for which the “Localities Prediction Table” has been constructed.

For example, to populate “Flag” field of the row for locality ““A”” in “Localities Prediction Table” at 8 AM, the “Locality Click Table” for locality ““A”” is searched for the value of “Flag” in the row for 8 AM, and that value is used.

### 2.3.2 GeneralAttributes

The subscriber “GeneralAttributes” are available from “Subscribers Attributes List”. The set of subscribers in each locality are characterised as per these attributes and their count is stored in “GeneralAttributes” of “Localities Prediction Table”.

The “Click Count” for an advertisement in a specific domain depends on the count of people with specific attributes in a locality. For example, if a locality has large number of students, there is a high probability of it having high “Click Count” for advertisements in “Sports” domain. Hence, a range of slabs for each attribute (like, “Age10-19” for “Age” attribute) are defined and the distributions of subscribers in these slabs in localities are determined.

For the locality in a given row of the “Localities Prediction Table”, the “Subscribers Attributes List” is searched for attributes of all subscribers who are residents of the locality. Now the count of people in that locality with specific gender, age slabs, ARPU slabs etc. is determined. These counts are stored in attributes like “GenderMale”, “GenderFemale”, “Age40-49”, “Age20-29”, “ARPU400-499”, etc. For example, if the locality has 1000 subscribers each with age 40, 42, 44, 46 and 48; the attribute “Age40-49” value will be 5000. Further, the total count of subscribers in the locality is stored in “Count” attribute.

### 2.3.3 VASAttributes

The “Click Count” for an advertisement in a specific domain depends on the count of people who have subscribed to specific VAS Elements in a locality. For example, if a locality has large number of subscribers subscribed to “Stock Quote” VAS Element, there is a high probability of it having high “Click Count” for advertisements in Financial Domain, like “IPO Promotions”.

Hence, attributes for each VAS Element are defined and populated the same with the total count of subscribers in the locality having subscribed to that element (for complete or fraction of period) in the “ObservationPeriod”.

For the locality in a given row of the “Localities Prediction Table”, the “Subscribers Attributes List” is searched for “VASAttributes” of all subscribers who are residents of the locality. For each VAS Element, counts (0 to 1) for all these subscribers are summed up and stored. For example, if the locality has 8000 subscribers who have subscribed to “News” for complete duration of “ObservationPeriod” and 4000 subscribers subscribed to “News” for half duration of “ObservationPeriod”, the attribute “News” value in “Localities Prediction Table” will be 10000.

It should be noted that since we are considering the case of Static Profiles, only the permanent residents in the locality are considered. The subscribers in the locality do not change as per hours of the day. Hence, in actual implementation of “Localities Prediction Table” a single separate data structure is created for “GeneralAttributes” and “VASAttributes” for a locality. In all the “Localities Prediction Tables” for different hours, the row for that locality entry would point to this same data structure (not shown in figures/methods).

### 2.3.4 ClickCount

The attribute has similar connotation as in “Locality Click Table”. For a “Known” locality in a given row of the “Localities Prediction Table”, the “Locality Click Table” for that locality is searched for the value of the “ClickCount” for the hour for which the “Localities Prediction Table” has been constructed.

For example, to populate “ClickCount” field of the row for locality ““A”” in “Localities Prediction Table” at 8 AM, the “Locality Click Table” for locality ““A”” is searched for the value of “ClickCount” in the row for 8 AM, and that value is stored.

All the localities in which advertisements were broadcast in that hour were marked as “Known” and a Classification is generated from them using “ClickCount” as the Class. The Classification is then run on the rest of the localities that were not sent advertisements in that hour (“Predicted”) and their “ClickCount” is populated as per the prediction.

### 2.4 Advertisement Delivery Table

Once the predictions of “ClickCount” have been made in “Localities Prediction Table” for all hours for an Advertising Domain, the “Advertisement Delivery Table” is constructed for that Advertising Domain (Table 6). The table is used to determine to what locality and hour combinations the advertisements should be sent to get high responses.

“Localities Prediction Table” for all hours are merged and their “ClickCounts” are ranked in descending order. The “Advertisement Delivery Table” is created with entries for these “ClickCounts”. Each row has the locality and hour at which this “ClickCount” is observed or has been predicted. The advertisements can now be broadcast as per this ranked order of locality and hour combination to get high responses. The attributes are—

Locality, Flag, ClickCount—These attributes have the same connotation as in “Localities Prediction Table”.

Hour—The entry has been extracted from a “Localities Prediction Table” for a specific “Hour”. This fieldd contains that “Hour” value.

TotalAds—The Content Service Provider schedules the advertisements to be broadcast in to a locality at each hour. This field contains the total advertisements scheduled to be sent in that locality in the hour of the entry. No more than “MaxAdsPerHour” should be scheduled per hour.

It should be noted that “TotalAds” and “MaxAdsPerHour” both represent the sum of advertisements being broadcast in all domains of advertising. However, each of the methods are defined specific to an advertising domain, the reference to these variables would be described as being specific to that advertising domain in our Flow Charts, to keep the description simple.

### 2.5 Subscribers in the Locality Table (Dynamic Profiles Case)

The downloaded application on the mobile phone conveys the location coordinates of the subscriber to the Content Service Provider server every “SyncPeriod”.

In case of Dynamic Profiles case, the Content Service Provider stores this historical data of subscribers in different localities at each hour of the day. The “Subscribers in the Locality” Table (Table 7) stores the phone number of subscribers in a locality at a specific hour. The table also stores information on whether these subscribers are permanent residents of the locality or are visiting the locality in that hour. Separate tables are made for each locality for each hour of the day. The description of attributes is—

Phone No.—The phone number of the subscriber in the locality.

ResidentialStatus—The phone number is searched in the “Subscribers Attributes List” to determine if the locality of permanent residence of subscriber is the current locality and the “ResidentialStatus” is marked as “Resident”. Else it is marked as “Visitor”.

### 2.6 Localities Prediction Table (Dynamic Profiles Case)

As in Static Profiles case, “Localities Prediction Table” is created per hour for Dynamic Profiles case (Table 8). Unlike Static Profile case, we are now considering the current set of subscribers in a locality at any hour, which includes both the “Residents” and “Visitors”. It should be noted that the advertisement clicking behaviour of these two categories differ. For example, the “Visitors” may be office goers who are in their office located in the locality. Since these are the office-hours, these subscribers would generally not click on advertisements in that hour. The “Resident” subscribers at that hour would be at home and have high probability of clicking on advertisements. Hence, in the table separate columns are created for “RESIDENTS” and “VISITORS”. For each of these categories, separate distribution of subscribers as per their attributes is stored. For example, separate attributes for “RESIDENTS Age40-49” and “VISITORS Age40-49” will be created and respective count of subscribers in the locality at that hour would be stored in them.

The attributes in the Table are—

Locality, Flag, ClickCount—These attributes have the same connotation as in Static Profiles case.

TOTAL—The total numbers of subscribers in the locality at that hour—the sum of “Residents” and “Visitors”.

RESIDENTS—The field stores attributes of all subscribers in the locality in that hour who are permanent residents of the locality. The attributes include the total “Count” of resident subscribers, their representation as a percentage of “TOTAL” subscribers in the locality at that hour, and distribution of subscribers as per their attribute values (similar “GeneralAttributes” and “VASAttributes” as in “Localities Prediction Table” of Static Profiles case).

VISITORS—The field stores attributes of all subscribers in the locality in that hour who are visitors to the locality. The attributes include the total “Count” of visitor subscribers, their representation as a percentage of “TOTAL” subscribers in the locality at that hour, and their distribution as per their attribute values (similar “GeneralAttributes” and “VASAttributes” as in “Localities Prediction Table” of Static Profiles case).

### 2.7 Localities Prediction Table (Real Time Profiles Case)

In case of Real Time Profiles case, the Content Service Provider first constructs historical “Localities Prediction Tables” like for Dynamic Profiles case. Further, it also gathers information about subscribers in a locality at the start of current hour in which advertisements have to be broadcast and constructs the “Localities Prediction Table” for the Current Hour (Table 9). The table has same attributes as “Table 8” with one difference. Since we would like to predict the “Click Count” in real time as per the attributes of current set of subscribers in the locality, the “Flag” for all the entries are marked as “Predicted”. Hence, the “Click Prediction Methodology” would need to be run on all the entries to determine the “Click Count” of different localities in the current hour.

### 3.2.8 Advertisement Delivery Table (Real Time Profiles Case)

The “Advertisement Delivery Table” (Table 10) for Real Time Profiles case is similar to “Advertisement Delivery Table” for Static Profiles case, with a difference that it is created only for the current hour. “ClickCounts” for all localities in “Localities Prediction Table” (Real Time Profiles Case) for current hour are predicted and ranked in descending order. The “Advertisement Delivery Table” is constructed with entries for these “ClickCounts”. Each row has the locality and this “ClickCount”. The attributes are—

Locality, ClickCount, TotalAds—Attributes have same connotation as in “Advertisement Delivery Table” for Static Profiles case.

### DETAILED DESCRIPTION OF THE FIGURES ALONG WITH WORKING OF THE INVENTION

While the invention is susceptible to various modifications and alternative forms, specific aspect thereof has been shown by way of example in the drawings and will be described in detail below. It should be understood, however that it is not intended to limit the invention to the particular forms disclosed, but on the contrary, the invention is to cover all modifications, equivalents, and alternative falling within the spirit and the scope of the invention as defined by the appended claims.

The Applicants would like to mention that the drawings are drawn to show only those specific details that are pertinent to understanding the aspects of the present invention so as not to obscure the disclosure with details that will be readily apparent to those of ordinary skill in the art having benefit of the description herein.

The terms “comprises”, “comprising”, or any other variations thereof, are intended to cover a non-exclusive inclusion, such that a setup, device that comprises a list of components does not include only those components but may include other components not expressly listed or inherent to such setup or device. In other words, one or more elements in a system or apparatus proceeded by “comprises . . . a” does not, without more constraints, preclude the existence of other elements or additional elements in the system or apparatus.

In the following detailed description of the aspects of the invention, reference is made to the accompanying drawings that form part hereof and in which are shown by way of illustration specific aspects in which the invention may be practiced. The aspects are described in sufficient details to enable those skilled in the art to practice the invention, and it is to be understood that other aspects may be utilized and that charges may be made without departing from the scope of the present invention. The following description is, therefore, not to be taken in a limiting sense, and the scope of the present invention is defined only be the appended claims.

We now present an example system and method for identifying and promoting advertisements to a group of specific users and/or to a specific set of localities for targeting advertisement for advertisement delivery platform over which this invention can be applied. The applicability of the invention is not limited to this specific system and can be applied in any other mobile advertising scenario/systems.

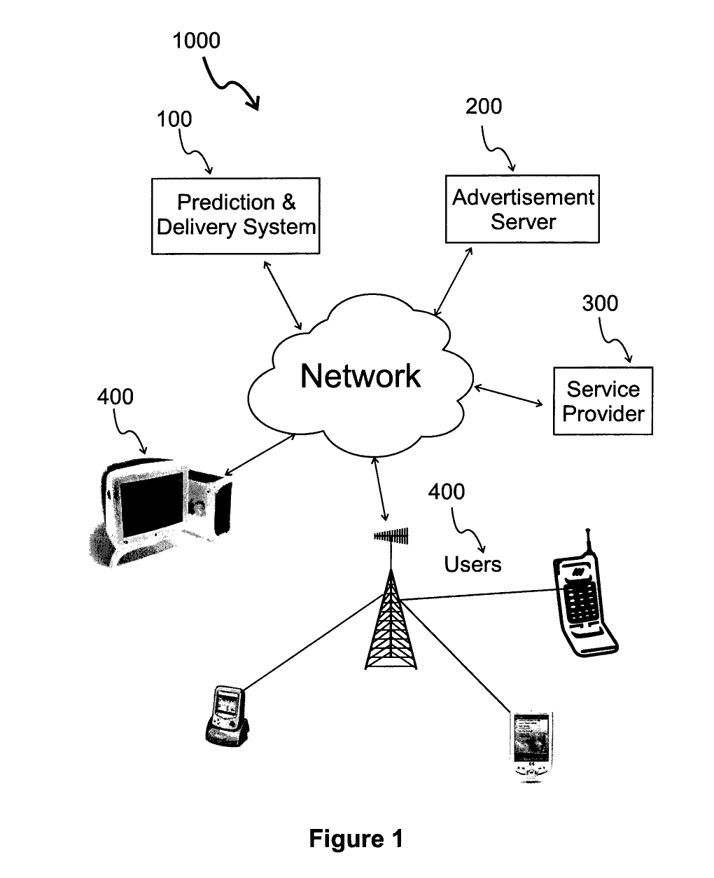

With reference to FIG. 1, the said figure represents a overall communication network comprising plurality of users, at least one service provider, at least one advertisement server for providing ads to the users and a prediction delivery system for predicting specific users and/or to a specific set of localities for targeting advertisement.

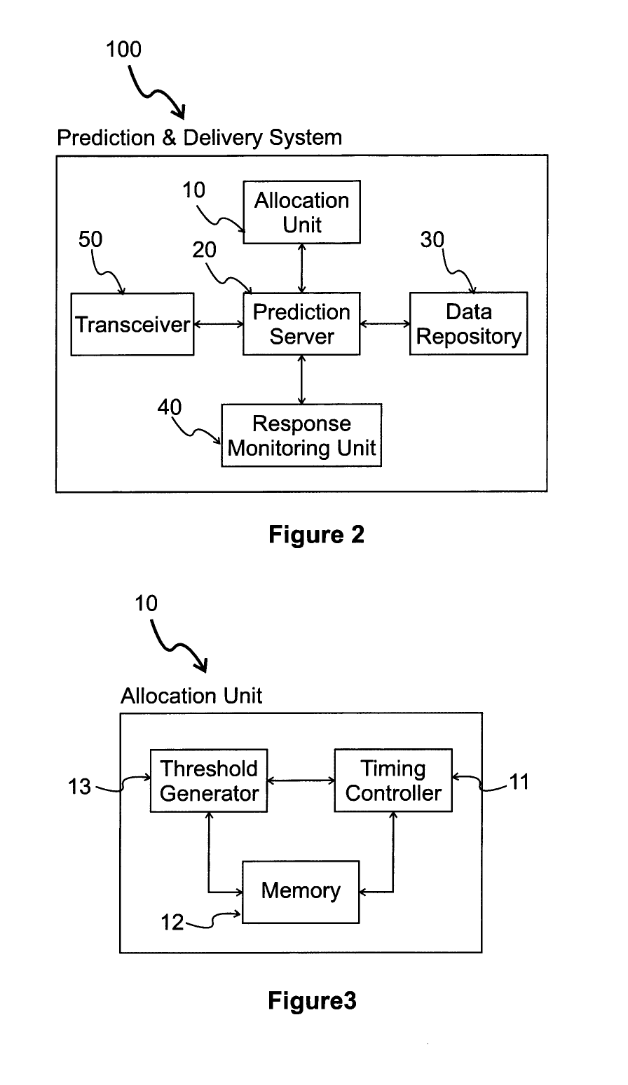

FIG. 2 represents a prediction and delivery system comprising a transceiver, for transmitting advertisements randomly to mobile users, an advertisement allocation unit for scheduling and controlling the timeslots for ads delivery and fair distribution; a response monitoring unit for monitoring the response & behavioural pattern of the mobile users; a data repository; and a prediction server for identifying specific users/set of localities for transmitting an advertisement.

FIG. 3 represents an advertisement allocation unit comprising a memory for storing the received response information; a threshold level generator for determining the number of advertisements to be sent to the mobile users based on the received response information; and an advertisement timing controller for predicting the time slots for sending advertisements during which the subscribers have highest probability of accepting advertisements and controlling the transmission of the advertisements.

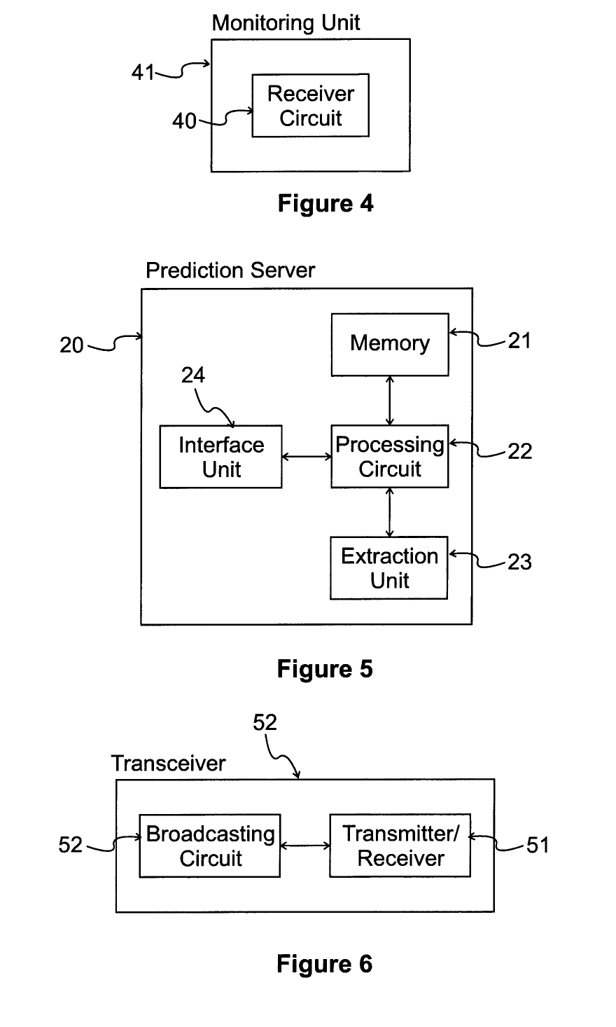

FIG. 4 represents a response monitoring unit comprises a receiver circuit for receiving a response and behavioural information for the mobile users.

FIG. 5 represents a prediction server for predicting a specific mobile users/or specific set of localities for targeting ads an interface unit; a memory; an extraction circuit configured to compute the response information of the mobile users; and a processing circuit further comprising at least one processor for classifying the reaction of a mobile user to the advertisement based on the response information by creating prediction-delivery matrix, generating preference summaries and extrapolating the generated preference summaries of the mobile users of the subset to the rest of the subscribers for identifying specific user group for transmitting an advertisement.

FIG. 6 represents a transceiver comprising a transmitter, receiver and a broadcasting circuit.

### DESCRIPTION OF FLOW CHARTS

The variables used in the Flow Charts are as below—

MAXK—Total number subscribers marked as “Known” (for given “AdDomain#k”) in “Subscribers Prediction Table”

MAXP—Total number subscribers marked as “Predicted” (for given “AdDomain#k”) in “Subscribers Prediction Table”

MAXS—Total number subscribers=(MAXK+MAXP)

MAXSLAB—Total number of slabs in “Advertisement Delivery Table”.

N—Total number of advertisement domains for which preference (“Click %”) has been predicted.

### DESCRIPTION OF FLOW CHART IN RESPECT A METHOD FOR PREDICTING SPECIFIC MOBILE USERS FOR TARGETING ADVERTISEMENTS

We consider the case of a Content Service Provider offering mobile content, also called Value Added Services (VAS), to mobile phone users (FIG. 1). The mobile phone users subscribe to the service to receive different contents being offered, like News, Stock Quote, Finance News, etc. At the time of subscription, the subscriber shares his/her demographic details like Gender, Age, Occupation, etc.

The subscribers can receive the content in multiple fashions—

i) A subscriber can permanently subscribe to a VAS Element (content) and regularly receive SMS messages containing that content, e.g., subscriber receives condensed “News” messages twice a day.

ii) Each VAS Element is assigned a unique SMS Short Code. A subscriber can send a request SMS message to the VAS Element SMS Short Code (at any time the day) and receives the content as SMS message, like condensed current “News”.

iii) Further, the content can also be made available through Voice Portal instead of SMS platform. E.g., a subscriber can make a voicecall to a Voice Portal Short Code or Phone Number and can receive the content in voice form.

iv) The Content Service Provider also hosts a WAP Content Portal displaying different types of content, which its subscribers can access from their mobile phones.

The Content Service Provider has also tied up with a number of Mobile Advertisers. The subscribers have the option to opt-in to receive mobile advertisements (Service Provider may give them the benefit of lower content subscription fees if they decide to opt-in). The Content Service Provider sends advertisements to these opted-in subscribers based on their predicted preferences for the advertisements, as per the prediction method given in this invention.

Our methodology predicts the probability of a subscriber accepting advertisements in specific domains (like, Financial Products, FMCG Products, etc.) based on their demographics and different types of contents being accessed by the subscriber. E.g., a subscriber who is accessing Stock Quote content is more likely to respond to advertisements promoting an IPO. We predicts the right time to send the advertisements to subscribers to get high responses. We describe an advertisement delivery logic that sends advertisements ensuring fair distribution among all subscribers and no overloading of some subscribers.

The advertisements can be sent in multiple modes, like SMS messages, Voicecall based promotions etc. For example, the subscriber is sent an SMS message with text giving information about some content (say a Caller Ring Back Tone—CRBT) and is asked to click on the accompanying URL to accept the content. If the subscriber clicks on the URL, the action is considered as the subscriber having accepted the advertisement. In case the subscriber does not have a WAP enabled phone he/she can be asked to send an SMS with text “Yes” to a predefined Short Code to accept the advertisement. In case of Voicecall based promotions, a voicecall is made to subscriber and then he/she is played multiple CRBT options to choose from. The subscriber then chooses the appropriate keypad key to accept the CRBT of choice. The action is considered as the subscriber having accepted the advertisement. For WAP Portal based advertisement display, the subscriber can click on the URL of the advertisement displayed on the portal. In the text of this patent application, we would refer to all actions of accepting an advertisement as an action of “Clicking” on advertisements irrespective of mode of delivery.

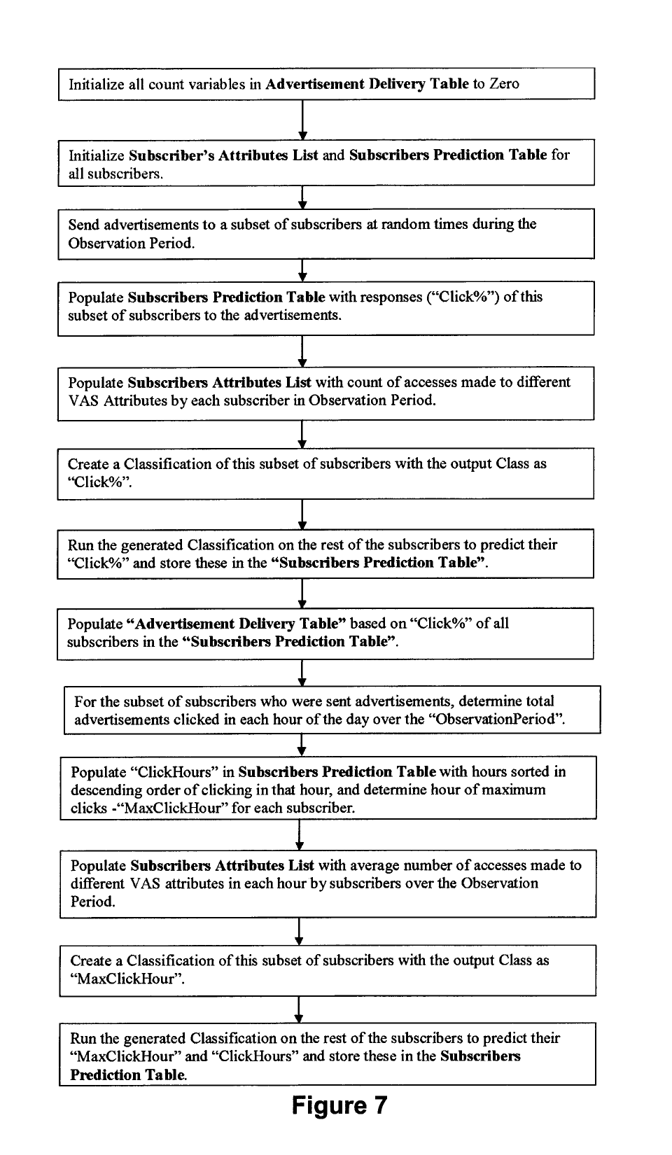

As regards FIG. 7, the said figure illustrates a flowchart exemplifying advertisement clicking prediction methodology. More specifically, the probability of a subscriber clicking on the advertisements and the predicted best time for sending the advertisements to the subscriber are determined.

The said flowchart is explained here below in detail:

### a). Initialisation

All the relevant variables in mentioned tables are initialised to their initial values. When a new subscriber joins the Content Service, he/she shares the demographics information, subscribes to some VAS Elements and may inform the maximum advertisements he/she wants to receive per day. The “Subscribers Attributes List” is populated with this information.

The subscriber is flagged as “Predicted” in “Subscribers Prediction Table” for all Ad. Domains since no advertisements have been as yet sent to the subscriber. The subscriber may provide some preferred hours in which the advertisements should be sent. The “TimeOpted” attribute is marked as “Yes” for such a subscriber and the “PreferredHours” attribute list is correspondingly populated.

### b). Click Prediction

The prediction of a subscriber to click an advertisement is made in this phase. A subset of subscribers are chosen and sent advertisements at random times during the “ObservationPeriod”. The total number accesses made by all the subscribers to different VAS Elements are counted and the “VAS Access Attributes” list is populated under “Subscribers Attributes List”. Under “Subscribers Prediction Table”, this selected subset of subscribers is flagged as “Known”. The percentage of advertisements clicked by these subset subscribers is determined as the “Click %” attribute. Although, not shown in methodology, it will be ensured that at least a minimum number of advertisements have been sent to the subscriber before he/she is marked “Known”, to avoid making wrong predictions.

The next step is to model the behaviour of these “Known” subscribers to predict the behaviour of other subscribers. All the “Known” subscribers are Classified. The demographics of a subscriber decide his/her interest in advertisements in specific domains. Further, if the subscriber is frequently accessing VAS Elements related to the domain of an advertisement, the probability of advertisement clicking is higher. Further, his past behaviour of clicking on advertisements is also important. Hence, the attributes used as inputs for Classification are “GeneralAttributes”, “ClickAttributes” and “PastClick %”. The “Click %” attribute is used as the Class (output attribute) for prediction.

The generated Classification is run on all “Predicted” subscribers in the “Subscribers Prediction Table” to predict their “Click %”.

### c). Populate Advertisement Delivery Table

The complete “Subscribers Prediction Table” is scanned. For each slab, the total count of subscribers with their “Click %” falling in the slab range is determined. The “Advertisement Delivery Table” is populated with these “SlabCount” values.

### d). Time to Click Prediction

The next step is to predict the best timeslot to send an advertisement to a subscriber. Unlike “Click Prediction” where separate prediction is made for each Advertising Domain, here we consider all advertisements (from all the Advertising Domains) sent to the subscriber in totality. If a subscriber is marked as “Known” in any one or more Advertising Domains, mark it as “Known”. Determine sum of “AdsSent” and “AdsClick” in all AdDomains and calculate the average “Click %”.

For each of these “Known” subscribers, the total advertisements (sum for all the Advertising Domains) clicked by the subscriber in each timeslot (hour of the day) is counted over the “ObservationPeriod”. The “ClickHours” attribute list in the “Subscribers Prediction Table” is populated with hours sorted in descending order of clicking in that hour. The hour in which the subscriber clicks the advertisement most number of times “MaxClickHour” is determined.

Next the relation between the activities of a subscriber in different hours of the day and the typical time he/she clicks the advertisements is determined. A subset of days (“SelectedDays”) in the “ObservationPeriod” in which the subscriber clicks high number of advertisements in “MaxClickHour” is determined. The “TimeToClickAttributes” for “Known” subscribers in “Subscribers Attributes List” are populated by determining average number of accesses to specific attributes in each hour over these selected days.

The “TimeToClickAttributes” for “Predicted” subscribers in “Subscribers Attributes List” are populated by determining average number of accesses to specific attributes in each hour over a totally random selection of “SelectedDays” in the “ObservationPeriod”.

A Classification Decision Tree is created using all the “Known” subscribers, except the ones who have not clicked any advertisements in the “ObservationPeriod”, to determine the preferred hours of clicking advertisements. The demographics of a subscriber decide his/her interest in advertisements in specific domains, e.g., an office worker may click after office-hours. Further, if the subscriber is accessing VAS Elements related to the domain of an advertisement at a specific hour, the probability of the advertisement being clicked is higher in that hour. Hence, the attributes used as inputs for Decision Tree creation are “GeneralAttributes” and “TimeToClickAttributes”. The “MaxClickHour” attribute is used as the Class for prediction.

The logic shown in the Flow Chart is used to predict “Click Hours” of subscribers as per their attribute values. The “ClickHours” Attribute List of all the “Predicted” subscribers in the “Subscribers Prediction Table” is populated as per these predicted values.

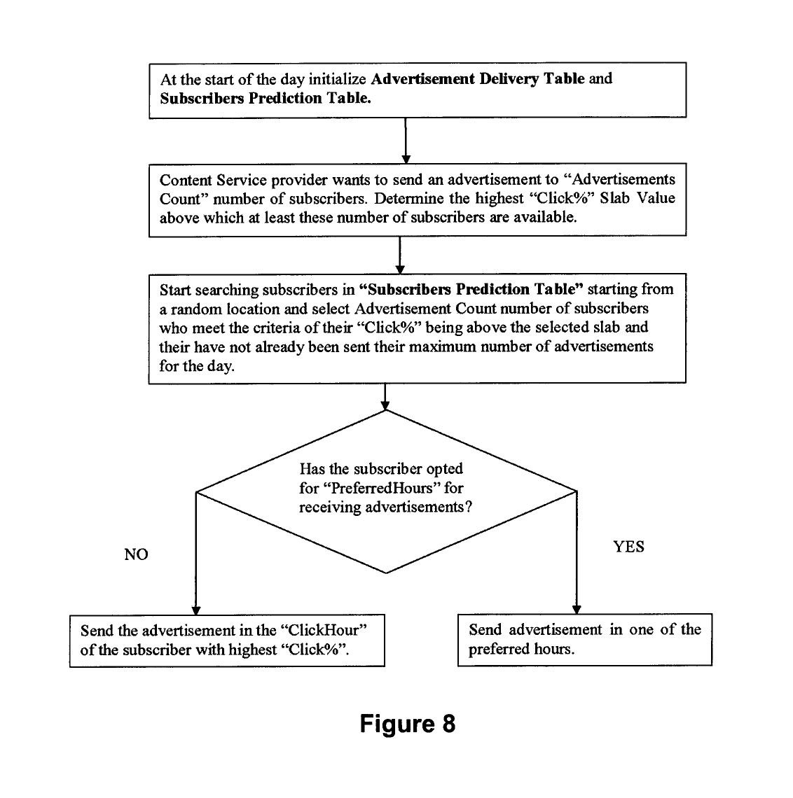

FIG. 8 represents a Flow Chart illustrating a Advertisement Delivery Methodology” is used to send the advertisements to these subscribers at the right time.

The methodology works in three phases and we shall explain flowchart here below in detail:

### I. Initialisation

At the start of the day, the “DaySlabCount” for all the slabs in “Advertisement Delivery Table” are initialised to their maximum value of “SlabCount”. Further, “DayAdsSent” for all subscribers is initialised to 0 in “Subscribers Prediction Table”.

### II. Select Right Slab

Let an Advertiser “K” ask for “AdvertisementsCount” number of advertisements (also called total “Impressions”) to be sent in the day. The “Advertisement Delivery Table” is searched starting from the highest “Slab” value (95%), to determine the “Slab” value above which at least “(FractionAds*AdvertisementsCount)” total subscribers are available for the day (by considering “DaySlabCount” values). The Slab value is marked as the “SelectedSlab” for this advertiser.

### III Deliver Advertisements

The methodology ensures that the advertisements are sent randomly to all subscribers to ensure fairness. Hence, the starting pointer in the “Subscribers Prediction Table” is chosen randomly and “(FractionAds*AdvertisementsCount)” number of subscribers are searched from this pointer. A subscriber is selected for sending the advertisement if its “Click %” is above the “SelectedSlab” and it has not already been sent his/her maximum number of advertisements for the day.

It has been observed that interest of subscribers in advertisements changes over a period of time. Hence, even subscribers currently with low response to advertisements may in the future start clicking more advertisements. To evaluate such behaviour, a fraction of advertisements “((1−FractionAds)*AdvertisementsCount)” is sent to random set of subscribers irrespective of their “Click %” value.

Next the right hour for sending the advertisement is determined. If the subscriber has opted for “PreferredHours” for receiving advertisements, and some of these hours are “valid” for the given Advertiser (i.e., fall within the start and end time of sending the advertisements of the Advertiser), one hour is chosen randomly from these hours and advertisement is sent.

Else, similar logic is used to determine “valid” hours among “ClickHours” of the subscriber and the hour with the maximum click probability is selected and advertisement is sent.

If none of the above hours are “valid”, a random hour is chosen (within the start and end time of sending the advertisements of the Advertiser) and advertisement is sent.

On sending the advertisement, the relevant counts are updated. “DayAdsSent” for the subscriber is incremented by 1 in “Subscribers Prediction Table”. If the maximum advertisements for the day have been sent to the subscriber, the “DaySlabCount” value is decremented by 1 for the slab this subscriber belongs to in “Advertisement Delivery Table”.

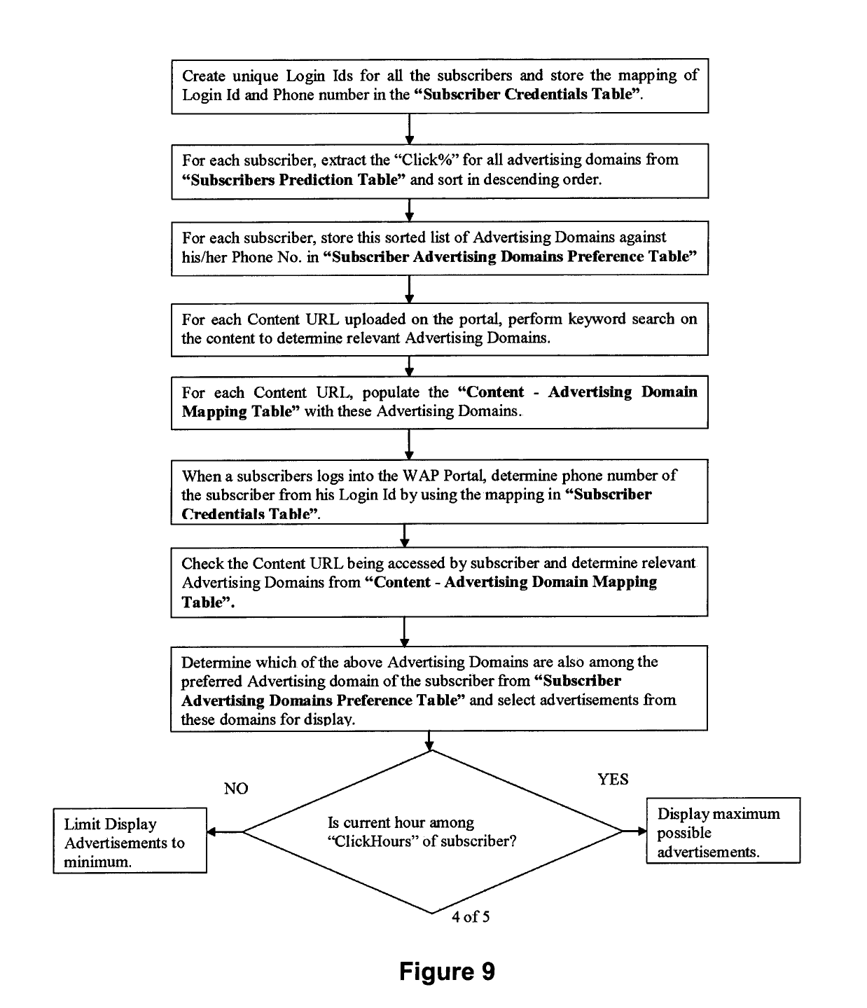

FIG. 9 represents a WAP Portal based Advertisement Delivery Methodology and shows the logic for the advertisements to be displayed to the subscriber when he/she accesses the Content Service Provider's WAP Portal.

The methodology works in two phases—

### I. Initialisation

When a subscriber joins the Content Service Provider network he/she creates a Login account to access the WAP Portal. The mapping of the Login Id and Phone number is stored in the “Subscriber Credentials Table”.

For each subscriber, his/her “Click %” for all the advertising domains is extracted from “Subscribers Prediction Table” and sorted in a descending order. A list of corresponding Advertising Domains (names) is created, with the Advertising Domain with maximum “Click %” being at top of the list, and so on. This list is stored in the “Subscriber Advertising Domains Preference Table” against the subscriber Phone No.

When a new content item is uploaded on the portal, perform keyword search on the content to determine relevant Advertising Domains. Populate the “Content—Advertising Domain Mapping Table” with these Advertising Domain names against the URL entry of the content.

### II. Advertisement Display

A subscriber logs in the portal and accesses some content. Determine phone number of the subscriber from his Login Id by using the mapping in “Subscriber Credentials Table”. From “Content—Advertising Domain Mapping Table” determine the Advertising Domains relevant to the content being accessed. From “Subscriber Advertising Domains Preference Table” determine the most preferred Advertising Domains of this subscriber. Determine which of these preferred domains are also relevant to the content being accessed, and display advertisements from these domains.

The methodology also checks if the subscriber has a habit of clicking advertisements during the current time. If he/she is accessing the content in one of his/her “ClickHours” in “Subscribers Prediction Table” then the subscriber is displayed maximum possible advertisements, since he has a high probability of clicking on advertisements. If instead, it is determined that he does not click any advertisements during the current hour, he is displayed lesser advertisements and the same space is shown for displaying more content.

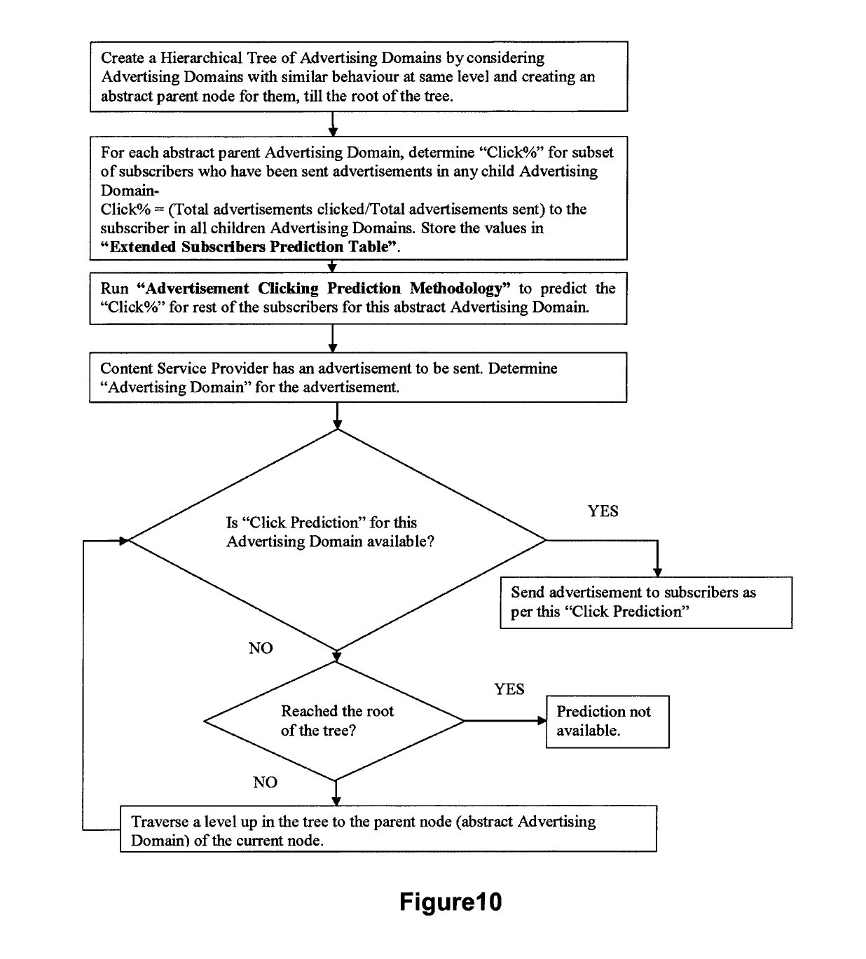

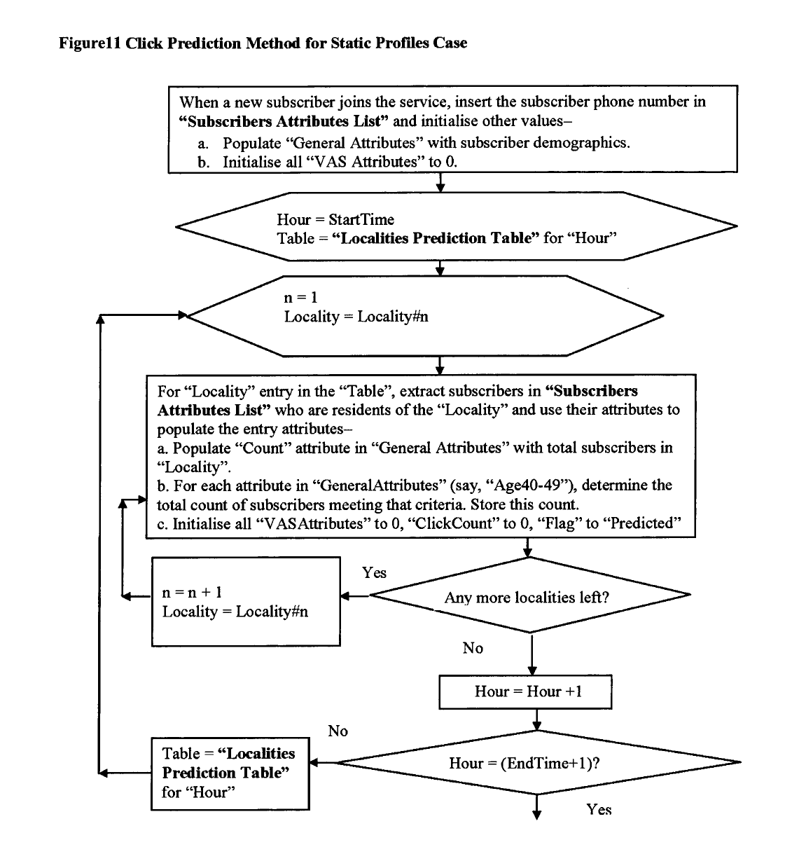

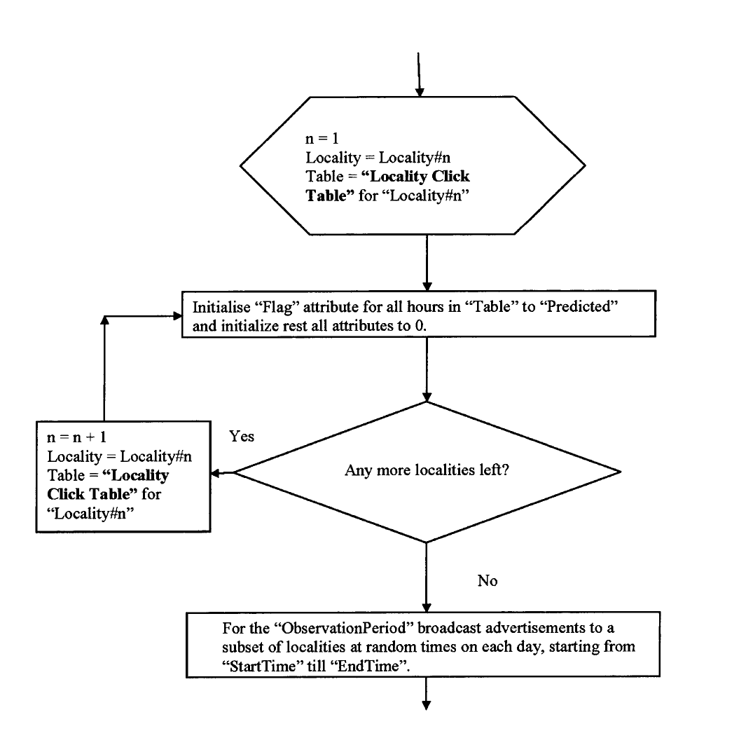

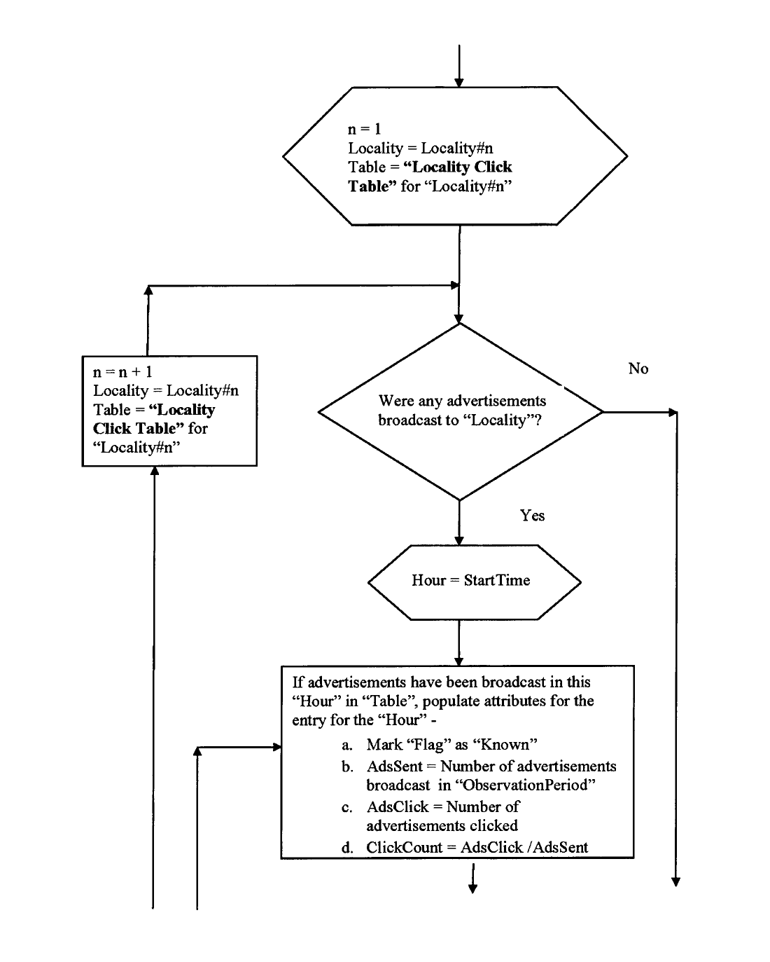

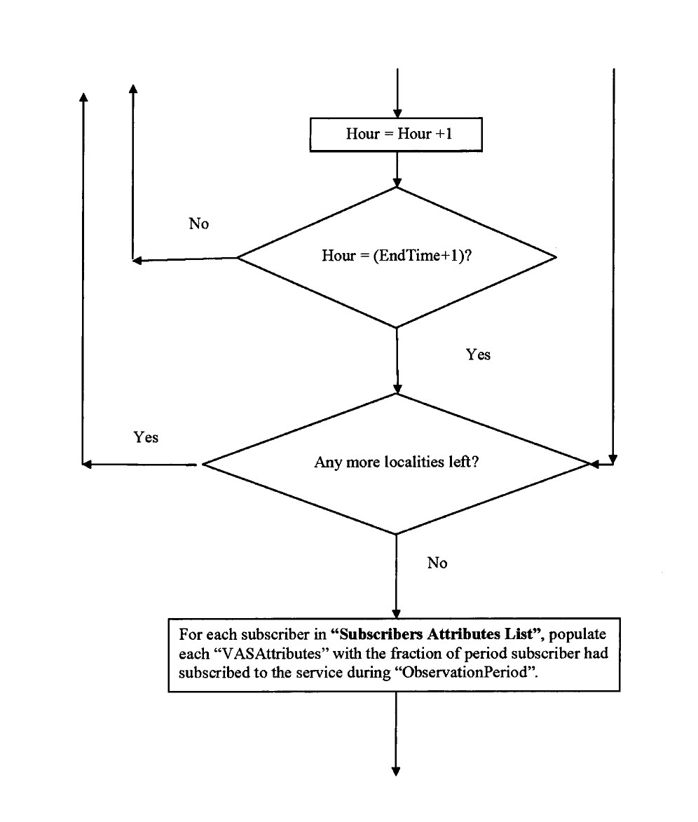

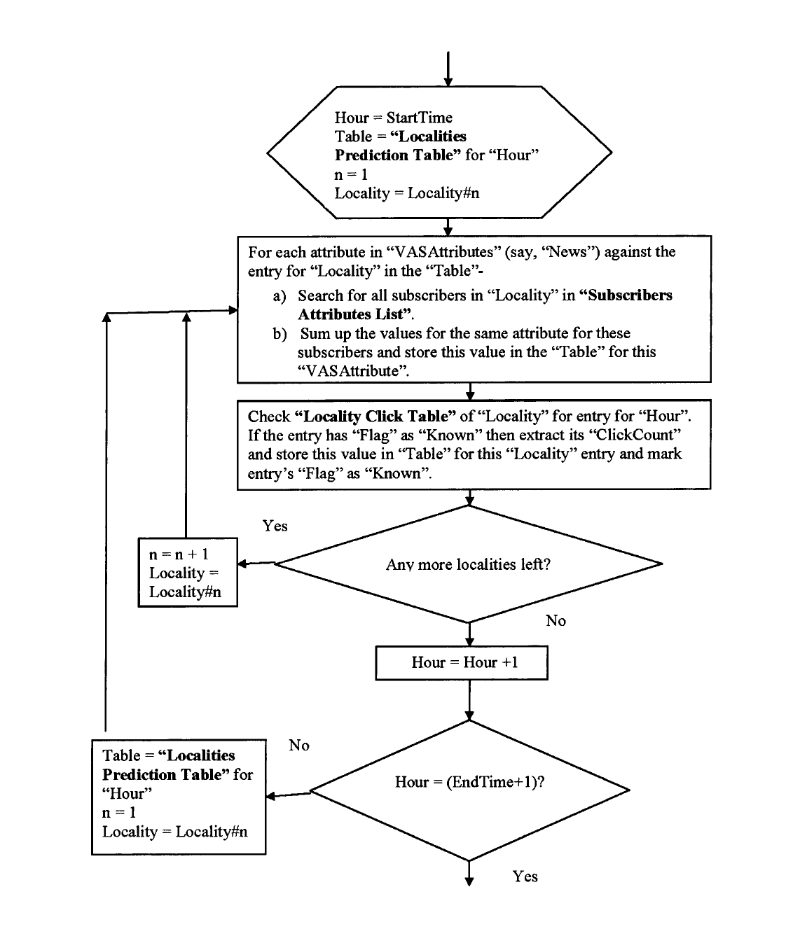

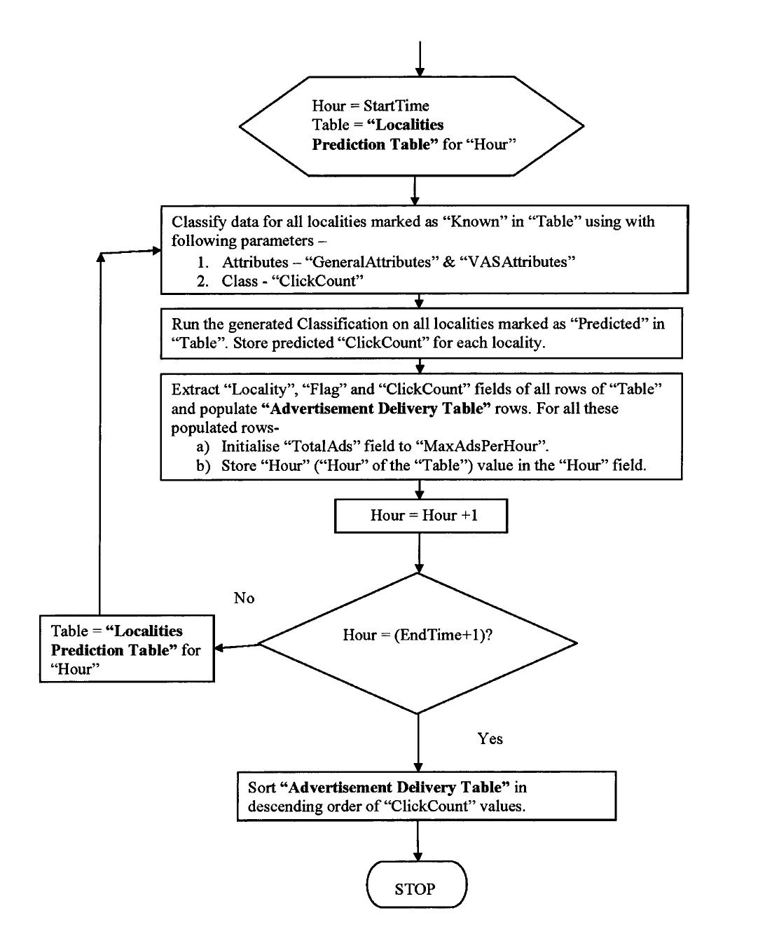

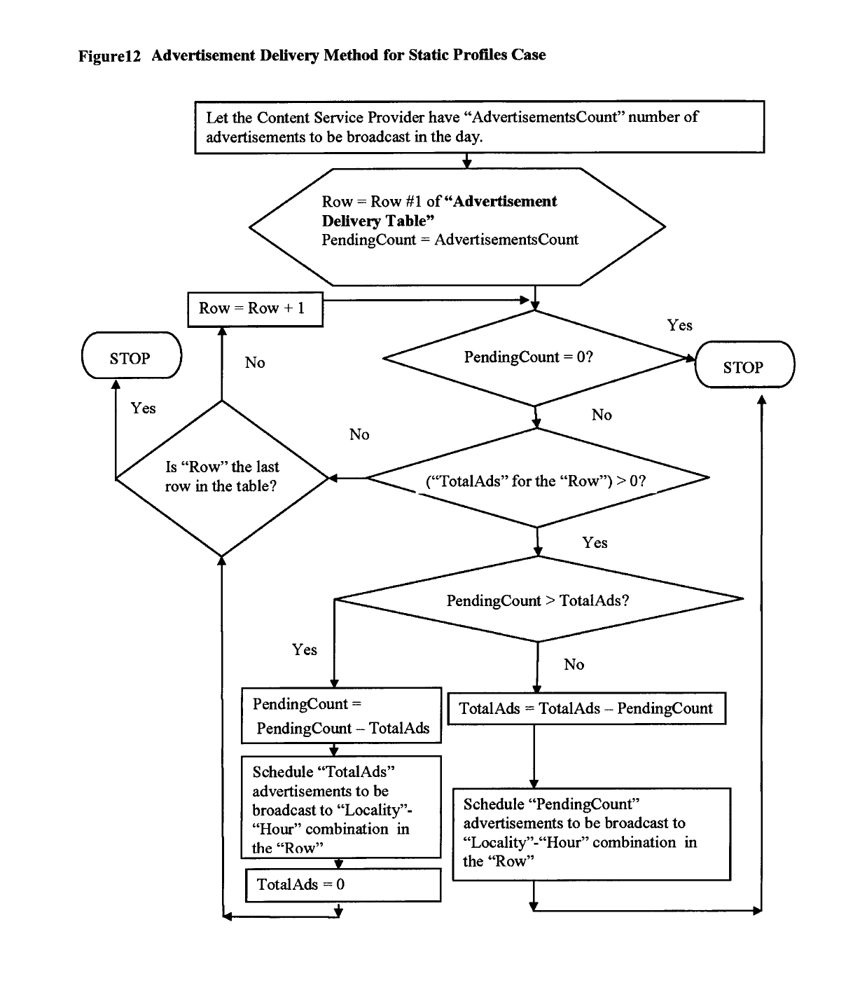

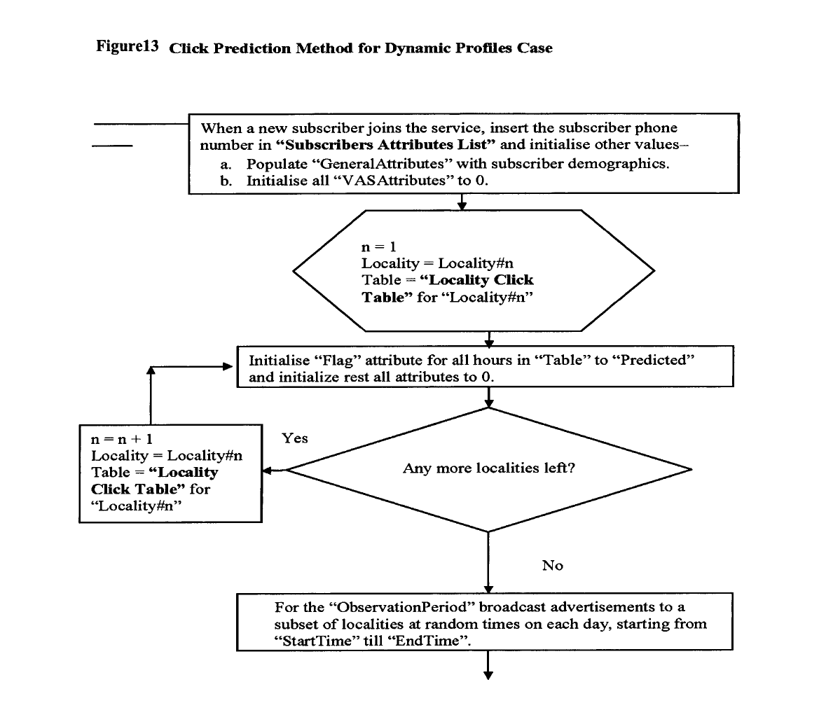

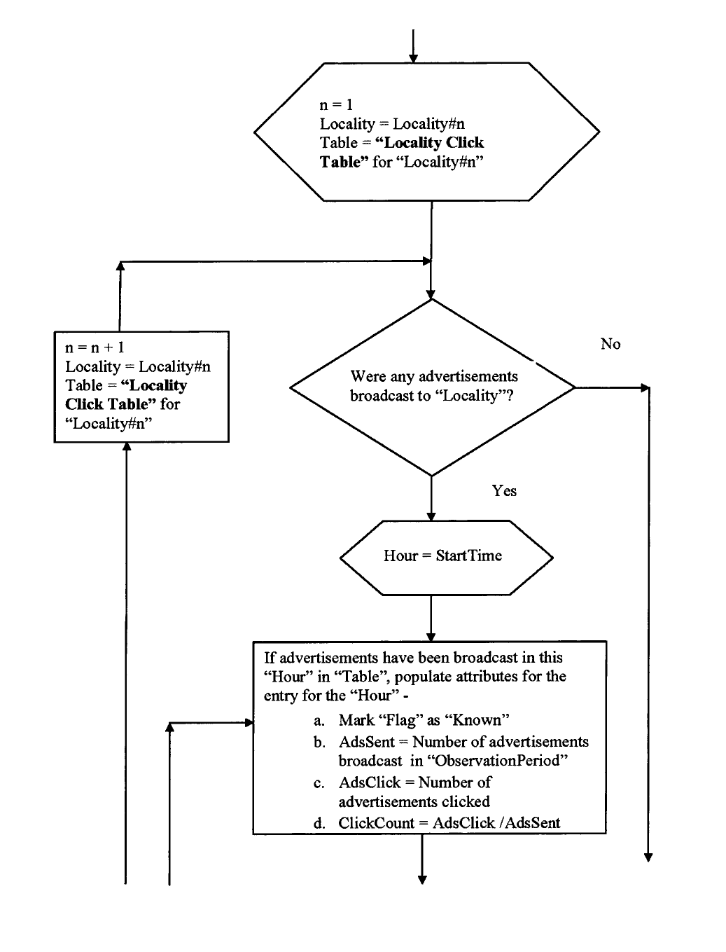

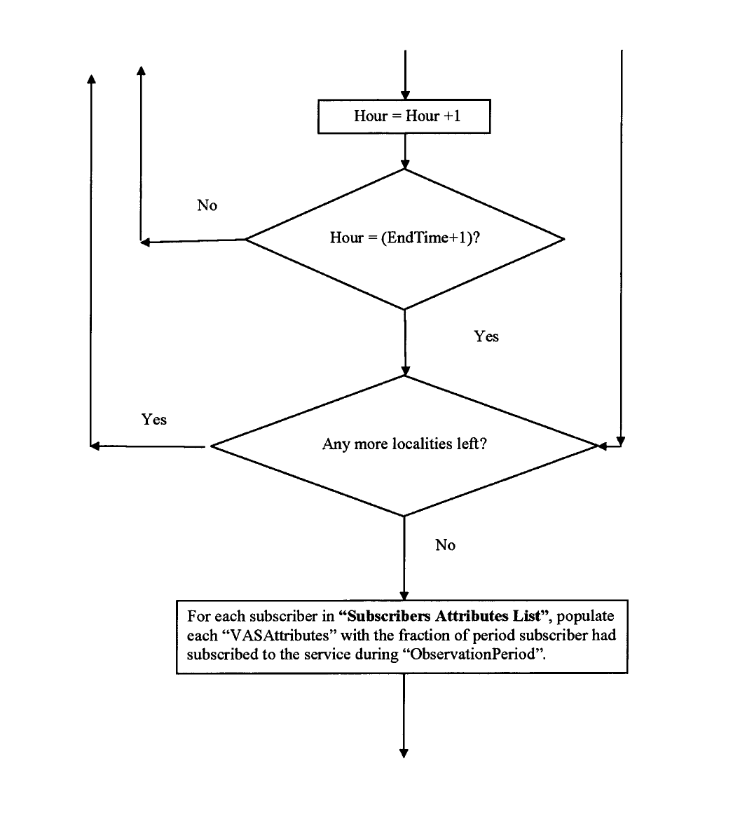

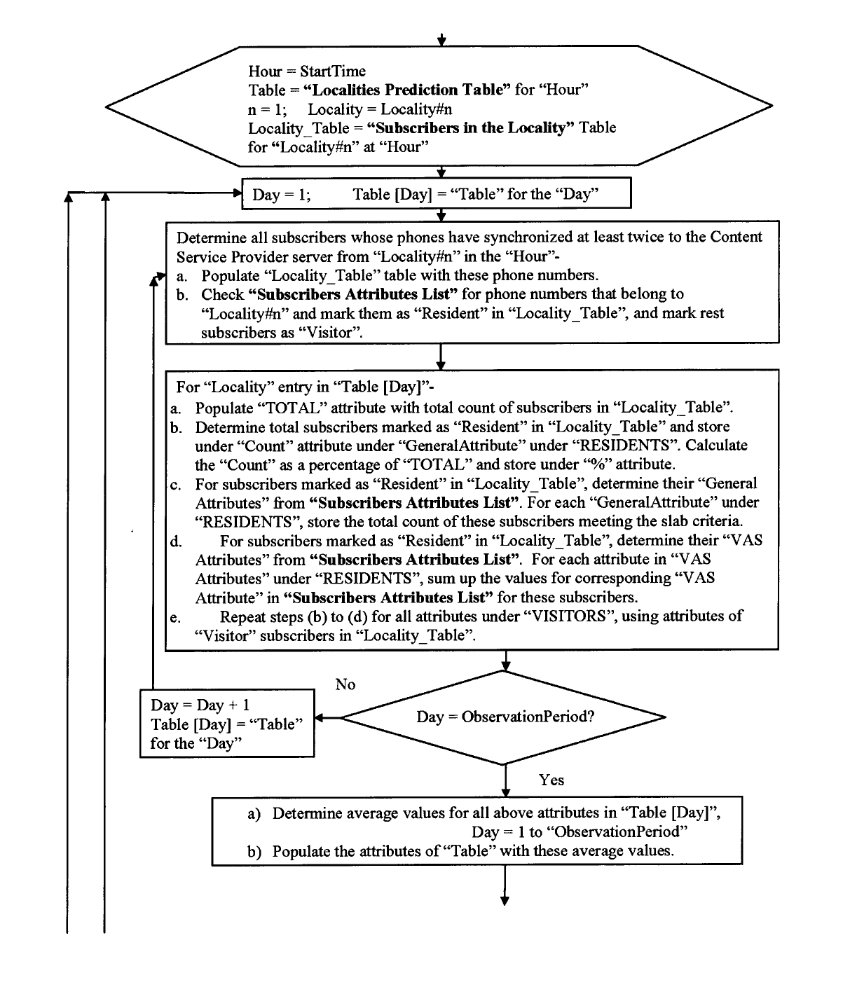

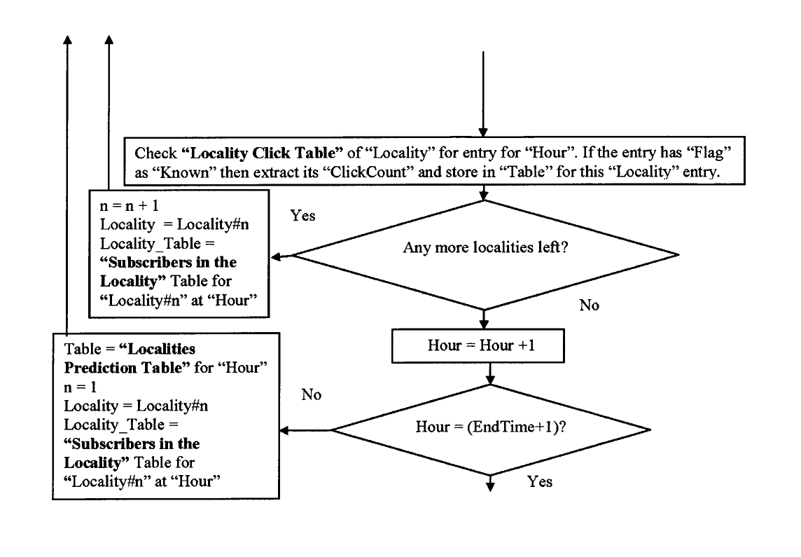

FIG. 10 represents an advertisement clicking prediction methodology for new Advertising Domains. More specifically, the said figure illustrates the logic of determining “Click %” for new Advertising Domains for which no previous history of sending promotions exists.

The methodology works in three phases—

### I. Initialisation

A Hierarchical Tree of Advertising Domains is created. Domains with similar behaviour are considered at same level and an abstract parent Advertising Domain is created for them. The process continues till the root of the tree. Table 9 shows such a hierarchical tree for abstract Advertising Domain “Movie”. Subscribers have been sent promotions earlier for “English Action” and “English Comedy” Movies but not for “English Historical” Movies. These nodes are abstracted to a parent abstract Advertising Domain as “English Movies”, and so on.

### II. Click Prediction

The “Click %” of the abstract Advertising Domains is determined in this step. The abstract Advertising Domain parent node is considered. The methodology checks if there are children Advertising Domains for which promotions have previously been sent to the subscriber. The sum of “AdsSent” and “AdsClick” for all these domains are used to calculate the average “Click %” of the parent abstract Advertising Domain in “Extended Subscribers Prediction Table”. Then, our “Advertisement Clicking Prediction Methodology” is run to predict the “Click %” for rest of the subscribers (“Predicted” subscribers) for this abstract Advertising Domain.

### III. Advertisement Delivery

When Content Service Provider has a requirement to deliver an advertisement to subscribers it checks the “Advertising Domain” for the advertisement. If this advertising domain's “Click Prediction” is already known, the advertisements are sent as per them. If the prediction is not known, the Hierarchical Tree is traversed from the leaf node to the root till an abstract Advertising Domain is found for which “Click Prediction” has earlier been determined. The advertisements are then sent as per the prediction for this abstract Advertising Domain.

### DESCRIPTION OF FLOW CHART IN RESPECT A METHOD FOR PREDICTING SPECIFIC SET OF LOCALITIES FOR TARGETING ADVERTISEMENTS

It should be noted that different Content Service Providers are in different stages of automation and information-gathering on their subscribers. Depending on the subscriber profiles details in a locality available with the Content Service Provider, we would present three cases for predicting the preference of a locality to broadcast advertisement. It would be clear that as we go down from Case 1 to Case 3, the accuracy of prediction improves but the information gathering and processing overheads increase for the Content Service Provider.
a) Static Profiles Case (Case 1)—A subscriber provides the information on his locality of permanent residence at the time of subscribing to the Content Service. The Static Profiles case assumes that a locality consists only of the permanent residents of the locality. There are no mechanisms available by which the visitors in the locality can be determined. Hence, for all hours on all days, the subscriber population for the locality is considered to be the permanent residents. The locality preference for a broadcast advertisement is predicted based on the preferences of permanent residents of the locality.
b) Dynamic Profiles Case (Case 2)—The Dynamic Profiles considers both the permanent residents and visitors in a locality at any hour. The historical data of the subscribers (both residents and visitors) in a locality for each hour for the past few days is used to predict locality preference for a future broadcast advertisement. Although, the historical data of subscribers in a locality is available but mechanisms to collect and use this information in real time are unavailable. The basic assumption made for prediction is that the future subscribers in the locality would be similar to past subscribers at any given hour. For example, in a locality with large number of offices, the subscribers visiting the locality during office-hours are generally the office-goers. These subscribers come to the locality daily, and hence our assumption is correct to a large extent.
c) Real Time Profiles Case (Case 3)—The Real Time Profiles case does not make any assumptions but uses the subscribers' real time profiles in a locality to predict the preference of a locality to a broadcast advertisement. The method proceeds as the Dynamic Profiles case by considering historical data of the subscribers (both residents and visitors) in a locality for each hour for the past few days only to create a prediction model for the locality preference for a future broadcast advertisement. At start of each hour of the day, all the subscribers currently in the locality are determined on real time basis. The preference for the locality for an advertisement is predicted for this real time subscriber profiles, using the earlier created prediction model. The advertisements are then broadcast to localities with high predicted preference for the advertisement.

We shall now describe the methods predicting the preference of a locality to broadcast advertisement. We would first describe the difference in the method of predicting preference of an individual subscriber for an advertisement to the method of predicting the preference of a locality (considering all its subscribers as a whole) for the advertisement.

In case of an individual subscriber, one predicts his/her preference for an advertisement using Classification mechanisms. Further, one separately predicts the timeslot he/she generally clicks on the advertisements (e.g., an office-goer generally clicks after office-hours). It should be noted that he is going to click all his preferred advertisements at this timeslot. Hence, a single timeslot needs to be predicted for all domains of advertisements that are clicked by the subscriber.

In case predicting the time an advertisement is clicked mostly in a locality. Let us take an example of a locality which has its majority resident subscribers as students, with high preference for Sports related advertisements. If these advertisements are broadcast in the morning or afternoon, these do not get high clicks since these students are then out of the locality, having gone to their schools/colleges. These advertisements start getting high Click Counts in the evenings, once the students are back in the locality.

Hence, Click Count for an advertising domain depends on the time at which it advertisements of that domain are broadcast to a locality. Hence, we need to predict the timeslot for a locality to click an advertisement separately for each Advertising Domain. Hence, our method predicts preference of a locality for advertisements separately for each hour of the day for each domain of advertisement.

Hence, each of our methods is making prediction for a specific Advertising Domain. The references in the methods to tables are also for tables for that specific Advertising Domain. This fact is implicitly assumed and hence is not being explicitly mentioned in the methods.

We would now describe the three cases in detail—Static Profiles, Dynamic Profiles and Real Time Profiles. Error handling and Boundary Conditions handling is not shown in the methods, to keep them simple.

### Predicating of the Specific Localities in Respect of Static Profiles

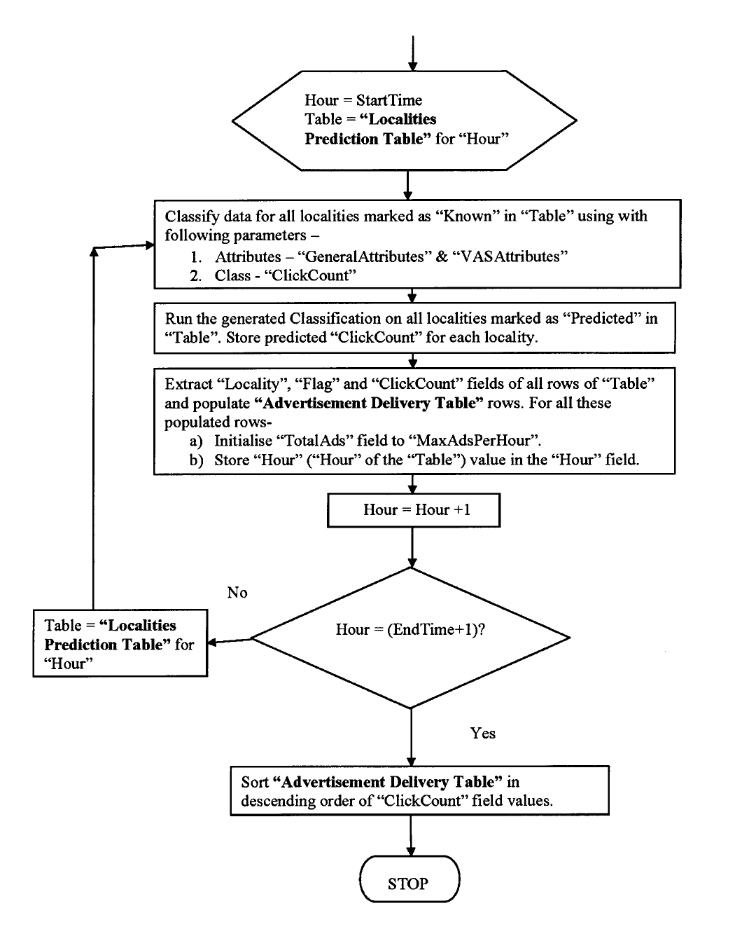

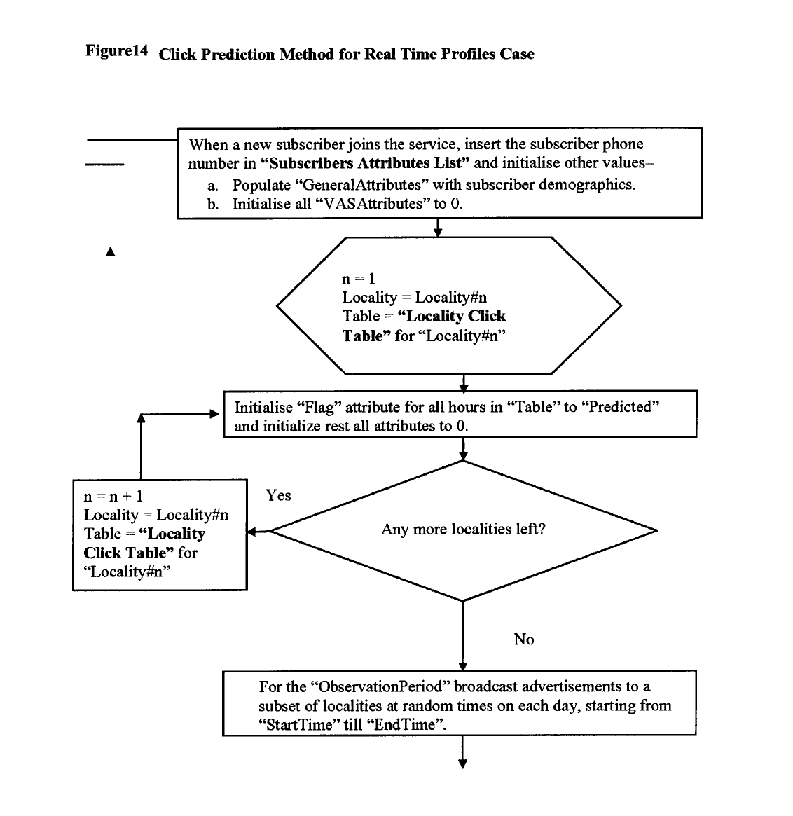

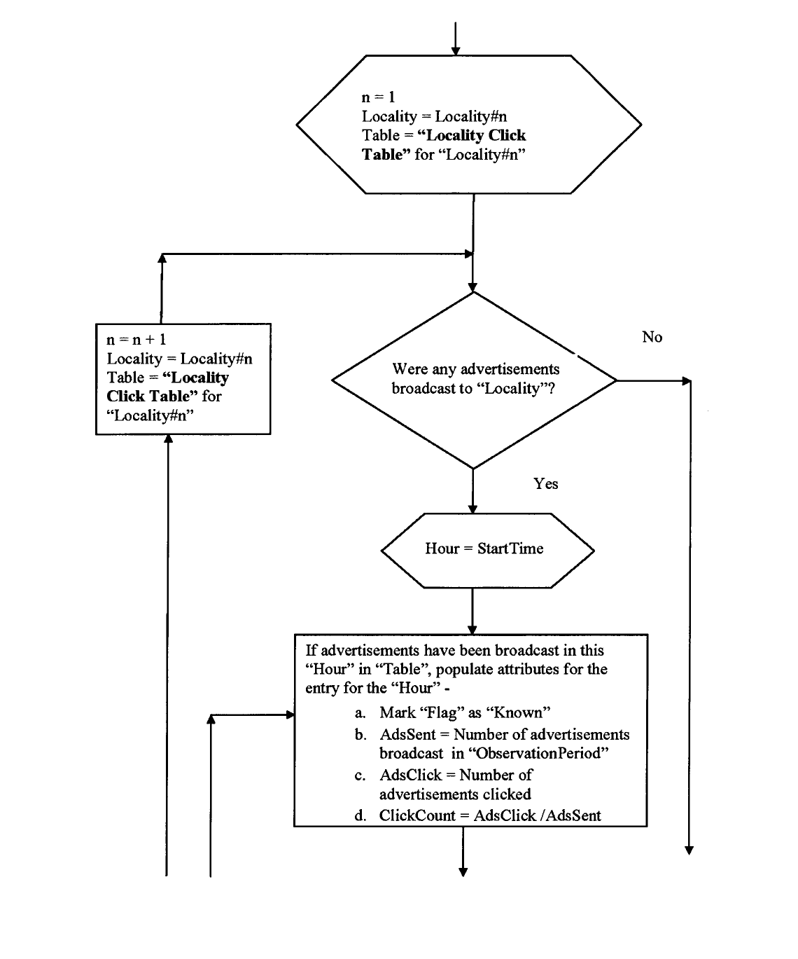

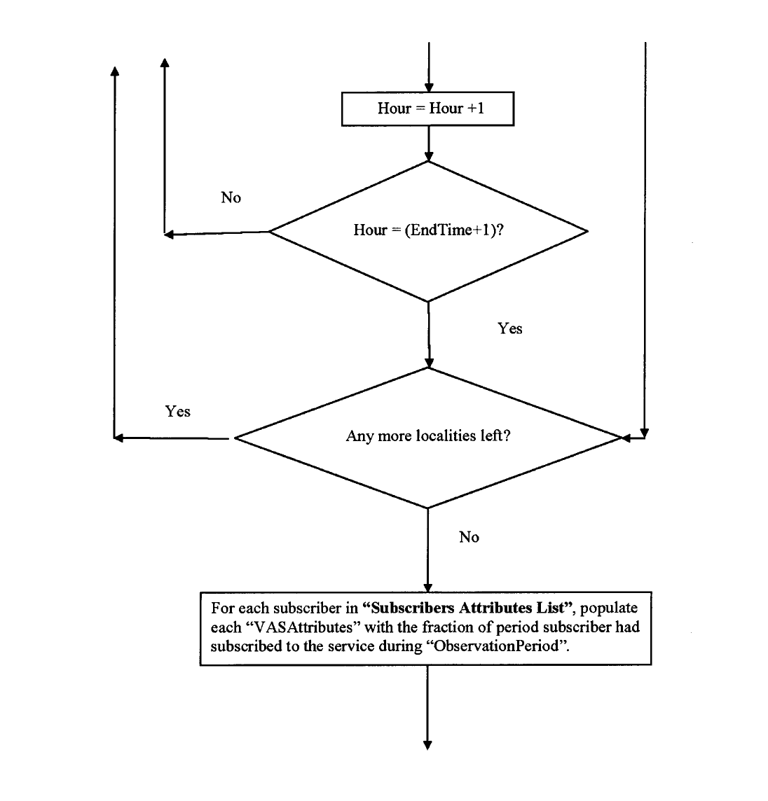

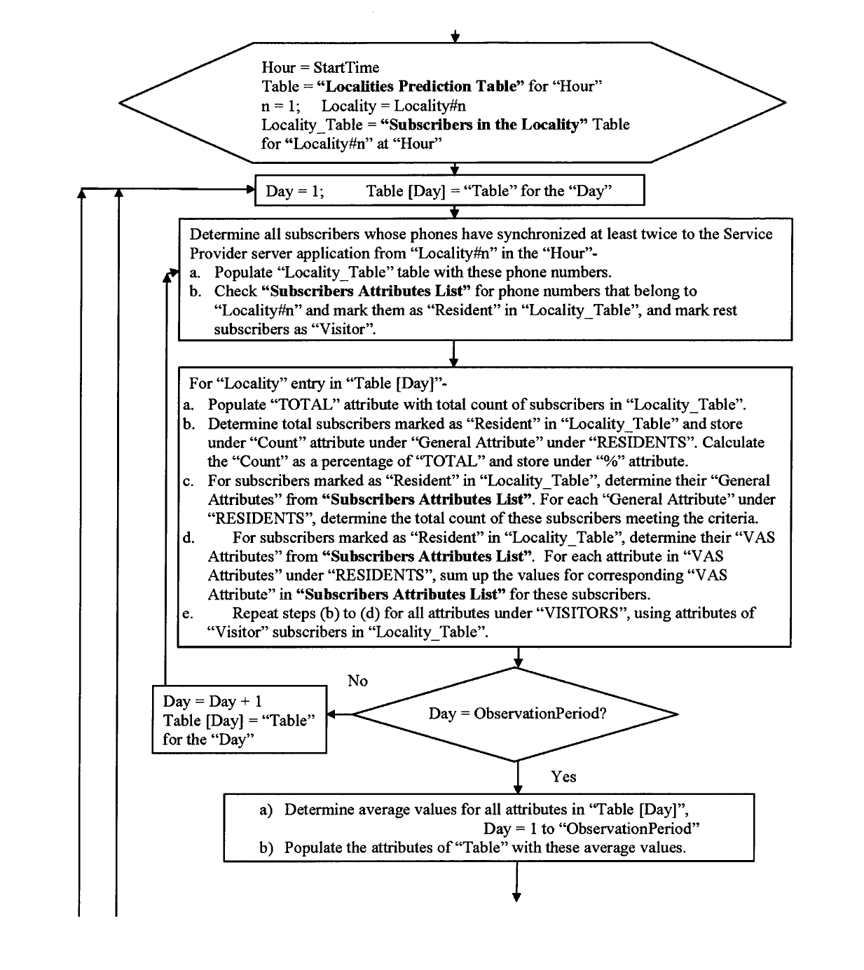

The detailed working of the method in respect of static profile is shown in Flow Charts 11 and 12. The prediction of “Click Count” of a locality for advertisements at different hours of the day is determined by method defined in “FIG. 11: Click Prediction Method for Static Profiles Case”. After this prediction has been made, method defined in “FIG. 12: Advertisement Delivery Method for Static Profiles Case” is used to broadcast the advertisements to these localities at the right time.

### a) Click Prediction Method

When a new subscriber joins the network, he/she shares his/her demographics (like, Locality, Age, etc.) with the Content Service Provider. The “GeneralAttributes” under “Subscribers Attributes List” are populated with these details for the subscriber (FIG. 2). Further, all “VASAttributes” are initialised to Zero.

Once “Subscribers Attributes List” has been populated with “General Attributes” of all subscribers, the information is used to populate the “Localities Prediction Table”. Starting from “StartTime” to “EndTime”, the “Localities Prediction Table” is created for each hour.

The total subscribers in that locality from the “Subscribers Attributes List” are stored in “Count” attribute. Now, for each attribute slab in “Localities Prediction Table”, the count of subscribers in the locality meeting that slab criteria is determined and stored.

Next “Locality Click Tables” are created for each locality. Entries are created for each hour of the day from “StartTime” to “EndTime” and “Flag” for each of these entries is initialised to “Predicted”.

Now advertisements are broadcast at random hours in different localities for the “Observation Period” and their “Click Counts” are determined. At the end of the period, the “Locality Click Tables” for each locality is populated. For each table, the hours in which advertisements were broadcast in the locality are marked with “Flag” value as “Known”. For each hour, the number of advertisements broadcast is stored under “AdsSent” and total clicked advertisements are stored under “AdsClick”. The “ClickCount” is calculated and stored.

For each subscriber in “Subscribers Attributes List”, each “VASAttributes” is populated with the fraction of period subscriber had subscribed to the service during “ObservationPeriod”.

Now the “Localities Prediction Tables” for each hour are populated. For the given “Observation Period”, the sum of values of each “VASAttribute” for all subscribers in a locality (from “Subscribers Attributes List”) is determined and stored under “VASAttribute” for that locality entry. The “Locality Click Table” is checked to see if the locality was broadcast advertisements in the given hour, and the entry is populated with “Flag” as “Known” and the extracted “ClickCount”.

At the end of the process we have created “Localities Prediction Tables” for each hour with a number of locality entries with “Known” “Click Counts” and rest locality entries as “Predicted” (for which “Click Count” is to be predicted). These “Known” entries are used to generate a Classification. The input attributes used are all the “GeneralAttributes” and “VASAttributes” and the output Class is the “ClickCount”.

The generated Classification is run on all the “Predicted” locality entries to predict their “ClickCount” for the given hour. The table is populated accordingly.

“Localities Prediction Tables” for all hours are then merged and sorted as per descending order of “ClickCount”. The final output is the “Advertisement Delivery Table” having a list of Locality-Hour combination entries with the value of “ClickCount” for the combination. We initialise “TotalAds” field to “MaxAdsPerHour” for all entries.

### b) Advertisement Delivery Method

The advertisements to be broadcast to localities are scheduled at the start of each day. Let the Content Service Provider have “AdvertisementsCount” number of advertisements in a specific advertising domain to be broadcast in a day (FIG. 3).

From the last section it can be noticed that the entries in “Advertisement Delivery Table” have been sorted as per the preferences of localities for the advertisement in specific advertisement domains. We start scheduling from the top entry in the “Advertisement Delivery Table” for the domain of the advertisement. A maximum of “TotalAds” are scheduled for broadcast to the “Locality” in the entry at the “Hour” in the entry. Then the pending advertisements are scheduled for broadcast in the “Locality”-“Hour” combination of the next entry. The process continues till all “AdvertisementsCount” advertisements have been scheduled.

Advertisements are then broadcast to these selected localities at the scheduled hours of the day.

### Predicating of the Specific Localities in Respect of Dynamic Profiles

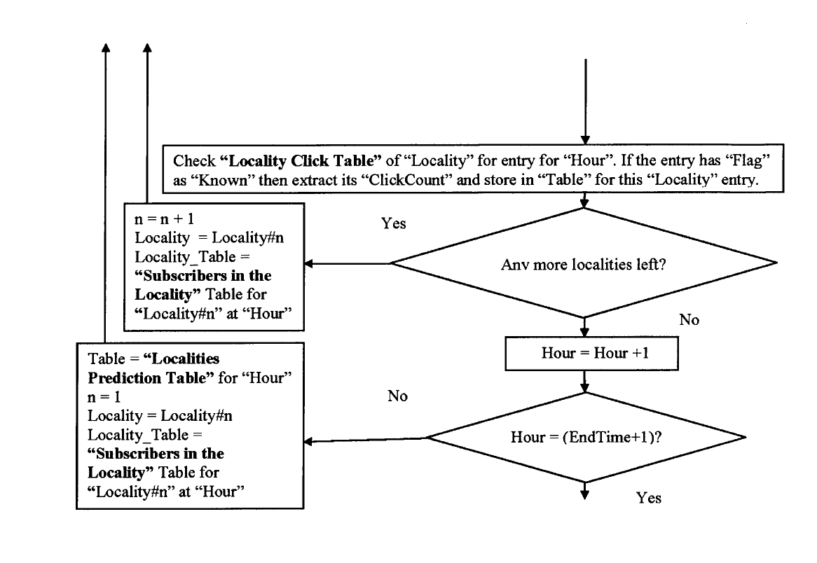

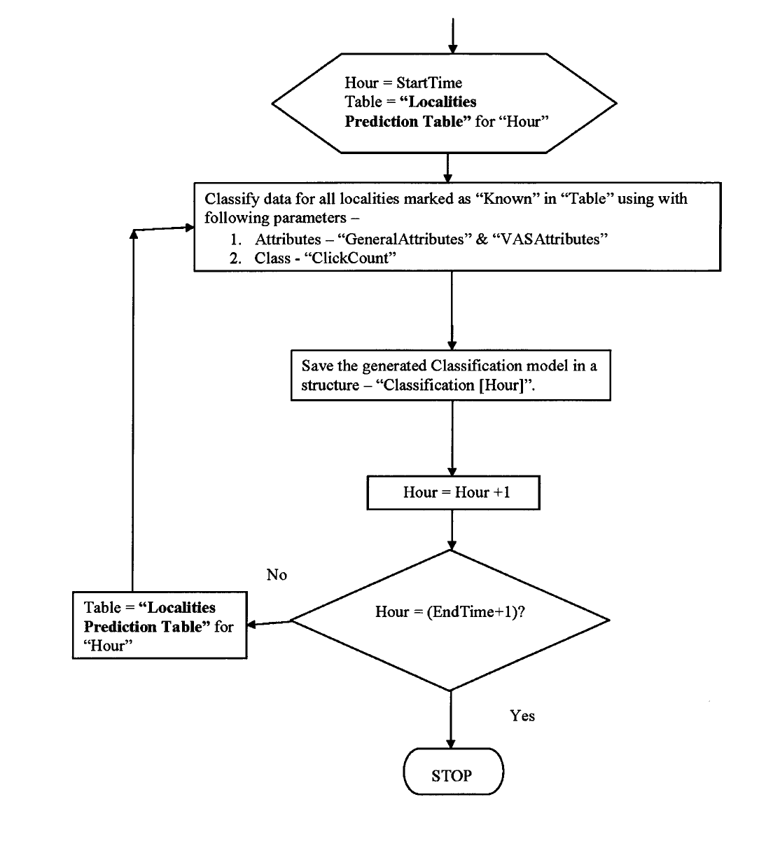

The prediction of Click Count of a locality for advertisements at different hours of the day is determined by method defined in “FIG. 14: Click Prediction Method for Dynamic Profiles Case”.

When a new subscriber joins the network, he/she shares his/her demographics. The “GeneralAttributes” under “Subscribers Attributes List” are populated with these details for the subscriber. Further, all “VASAttributes” are initialised to Zero.

Next “Locality Click Tables” are created for each locality. Entries are created for each hour of the day from “StartTime” to “EndTime” and “Flag” for each of these entries is initialised to “Predicted”.

Now advertisements are broadcast at random hours to a subset of localities for the “Observation Period” and their “Click Counts” are determined. At the end of the period, the “Locality Click Tables” for each locality is populated. For each table, the hours in which advertisements were broadcast in the locality are marked with “Flag” value as “Known”. For each hour, the number of advertisements broadcast is stored under “AdsSent” and total clicked advertisements are stored under “AdsClick”. The “ClickCount” is calculated and stored.

For each subscriber in “Subscribers Attributes List”, each “VASAttributes” is populated with the fraction of period subscriber had subscribed to the service during “ObservationPeriod”.

Now the “Localities Prediction Tables” for each hour are populated. We populate the fields for each “Locality#n” entry in the table for the “Hour#m” for which the table has been created. We first determine the subscribers who are in “Locality#n” in the “Hour#m”. The mobile phone of a subscriber synchronises with the Content Service Provider server thrice in an hour. If the location coordinates of the phone tell that it has synchronised from “Locality#n” at least twice in the “Hour#m”, it can be assumed that the subscriber has spent majority of his/her time in “Locality#n”. Hence, we populate the “Subscribers in the Locality “Locality#n” at “Hour#m”” table with all the subscribers who have synchronised at least twice from “Locality#n” in “Hour#m”.

Now, the “ResidentialStatus” field for each subscriber is set as “Resident” if the subscriber originally belongs to “Locality#n” (from subscriber demographics in “Subscribers Attributes List”) else it is set as “Visitor”. The total number of subscribers in the locality is stored in the “TOTAL” attribute for “Locality#n” entry in “Localities Prediction Tables”. Further, distribution of counts (and %) of “Residents” and “Visitors” is separately stored in the entry.

The “General Attributes” of “Resident” subscribers are determined from “Subscribers Attributes List”. For each “General Attribute” slab in “Localities Prediction Table”, the count of these subscribers meeting that slab criteria is determined and stored. For the given “Observation Period”, the sum of values of each “VAS Attribute” for all these subscribers (from “Subscribers Attributes List”) is determined and stored under the corresponding “VAS Attribute” in this locality entry for “Localities Prediction Table”.

The above steps are repeated to populate the “General Attributes” and “VAS Attributes” for all “Visitor” subscribers for the locality entry in “Localities Prediction Table”.

The process is repeated for each day of the “Observation Period” and the average values of attributes over all days are stored in the final “Locality#n” entry in “Localities Prediction Table” for “Hour#m”.

The “Locality Click Table” is checked to see if “Locality#n” was broadcast advertisements in the “Hour#m”, and the “Locality#n” entry in “Localities Prediction Table” is populated with “Flag” as “Known” and the extracted “ClickCount”.

At the end of the process we have created “Localities Prediction Tables” for each hour with a number of locality entries with “Known” Click Counts and rest locality entries as “Predicted”. These “Known” entries are used to generate a Classification. The input attributes used are all the “GeneralAttributes” and “VASAttributes” and the output Class is the “ClickCount”.

The generated Classification is run on all the “Predicted” locality entries to predict their “ClickCount” for the given hour. The table is populated accordingly.

“Localities Prediction Tables” for all hours are then merged and sorted as per descending order of “ClickCount”. The final output is the “Advertisement Delivery Table” having a list of Locality-Hour combination entries with the value of “ClickCount” for the combination.

Once the “Advertisement Delivery Table” has been created, the method for delivery of advertisements is similar to “Advertisement Delivery Method for Static Profiles Case” (FIG. 3), and hence is not being described separately.

### Predicting Specific Localities in Respect of Real Time Profiles

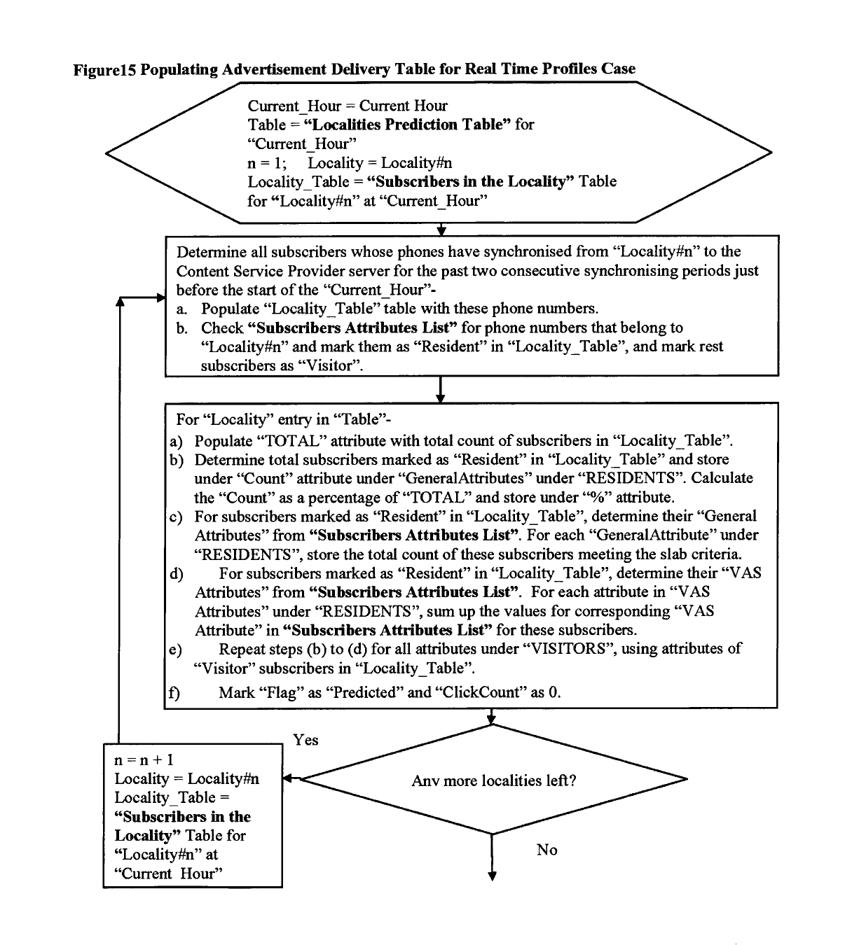

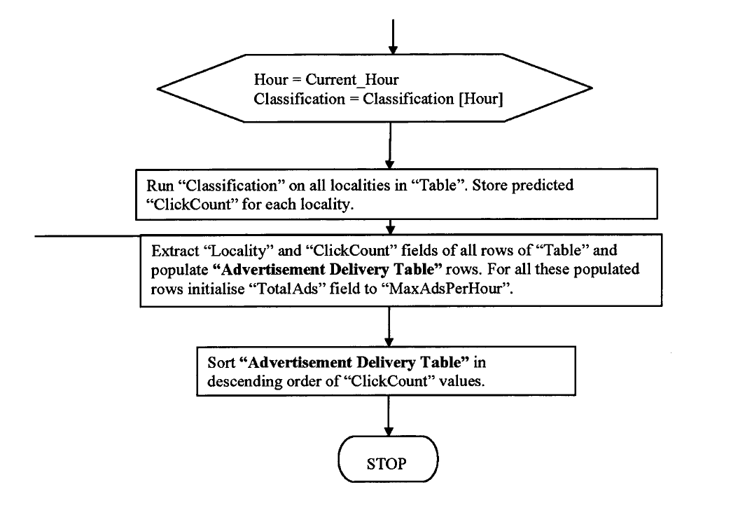

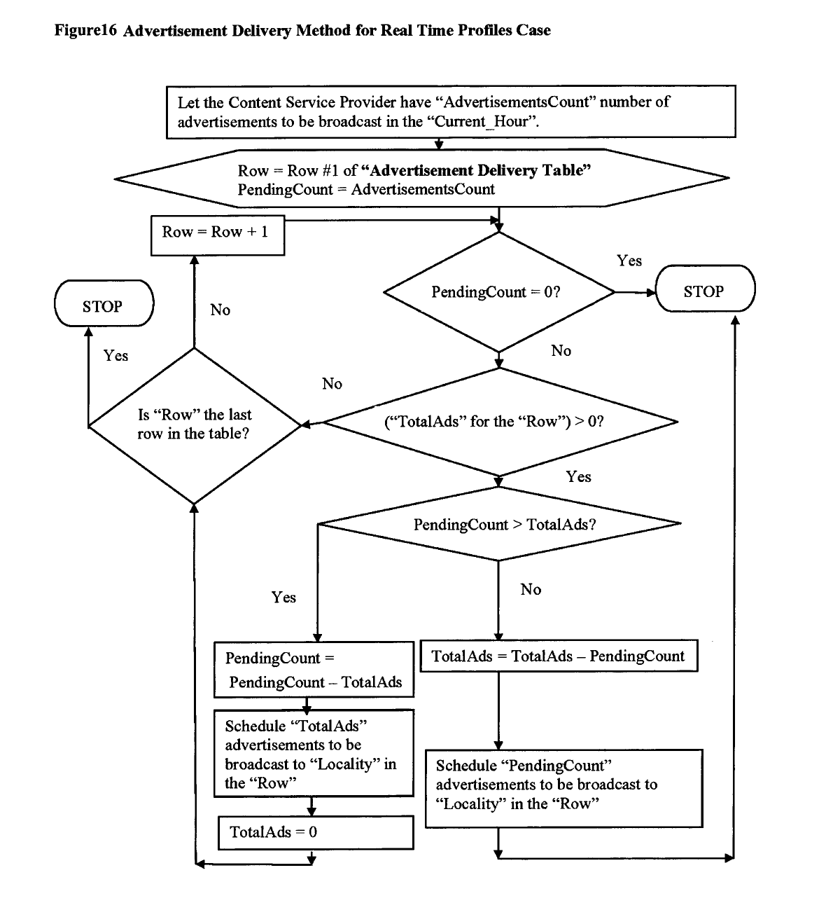

The creation of Classification Models for predicting “Click Count” of localities for advertisements at different hours of the day is determined by method defined in “FIG. 14: Click Prediction Method for Real Time Profiles Case”. Once the models have been created, the subscribers in different localities at a given hour are determined on real time basis and the method “FIG. 15: Populating Advertisement Delivery Table for Real Time Profiles Case” is run to apply the above model to predict the “Click Counts” of the localities to create the “Advertisement Delivery Table”. Finally, “FIG. 16: Advertisement Delivery Method for Real Time Profiles Case” is run to broadcast advertisements to localities with high “Click Counts”.

### a) Click Prediction Method

The steps in the method are exactly the same as in Dynamic Profiles case (Section 3.3.2) till the point of populating “Localities Prediction Tables” for each hour with a number of locality entries with “Known” Click Counts and rest locality entries as “Predicted” (FIG. 14).

As before, these “Known” entries are used to generate a Classification Model for the hour for which the “Localities Prediction Table” has been created. However, unlike Dynamic Profiles case, the generated Classification is not run over the “Predicted” locality entries in the table.

It is important to note the difference between “Dynamic Profiles” and “Real Time Profiles” cases. In case of “Dynamic Profiles”, it is assumed that subscribers who are historically in a locality at a particular hour will repeat in the future in the same locality at the same hour. Hence, the locality entries in “Localities Prediction Table” specify subscriber attributes that would also occur in the future and advertisements should be broadcast as per predictions made as per these attributes. Hence, the “Classification” generated using the “Known” entries is run over all the “Predicted” entries and their “Click Count” is predicted, and stored in “Advertisement Delivery Table”.

On the other hand, in case of “Real Time Profiles”, we do not make any assumptions about the subscribers in a locality in the future. The actual subscribers in a locality at any hour are determined on real time basis in that hour. The advertisements are then broadcast as per the predictions based on attributes of these subscribers.

Hence, although Classifications are generated using “Known” locality entries for each “Localities Prediction Table” however, we do not run it over the “Predicted” locality entries, since the subscribers in these localities may vary in the future. These per hour “Classification” models are generated and saved to be applied in the next method step.

### b) Populating Advertisement Delivery Table

When the Content Service Provider needs to decide the localities for broadcasting advertisements in the current hour, it creates the “Advertisement Delivery Table” on real time basis for (FIG. 15).

Accordingly, the fields are populated for each “Locality#n” entry in the “Localities Prediction Table” for the current hour. First of all, the subscribers who are in “Locality#n” are determined at start of the current hour and are expected to stay in the locality for most of the current hour. The mobile phone of a subscriber synchronises with the Content Service Provider server thrice in an hour. If the location coordinates of the phone tell that it has synchronised from “Locality#n” for immediate past two synchronisation periods in the hour preceding the current hour, it can be safely assumed that the subscriber has been in the locality for a sufficiently long period and is likely to remain in the same locality for current hour (i.e., subscriber was not just passing by the locality when his mobile phone synchronised). Hence, the “Subscribers in the Locality “Locality#n” table with all these subscribers are populated.

Now, the “ResidentialStatus” field for each subscriber is set as “Resident” if the subscriber originally belongs to “Locality#n” (from subscriber demographics in “Subscribers Attributes List”) else it is set as “Visitor”. The total number of subscribers in the locality is stored in the “TOTAL” attribute for “Locality#n” entry in “Localities Prediction Tables”. Further, distribution of counts (and %) of “Residents” and “Visitors” is separately stored in the entry.

The “General Attributes” of “Resident” subscribers are determined from “Subscribers Attributes List”. For each “General Attribute” slab in “Localities Prediction Table”, the count of these subscribers meeting that slab criteria is determined and stored. The sum of values of each “VAS Attribute” for all these subscribers from “Subscribers Attributes List” is determined and stored under the corresponding “VAS Attribute” in this locality entry for “Localities Prediction Table”.

The above steps are repeated to populate the “General Attributes” and “VAS Attributes” for all “Visitor” subscribers for the locality entry in “Localities Prediction Table”.

Since, the “Click Counts” for all the localities in real time are needed to be predicted, the “Flag” fields for all the entries are marked as “Predicted” and “ClickCount” is initialised to 0.

The Classification Models were created for each hour of the day. The Classification model for the hour equaling current hour is extracted and run on all locality entries in the “Localities Prediction Table” to predict their “ClickCount” for the given hour. The table is populated accordingly.

The table is sorted as per descending order of “ClickCount”. The final output is the “Advertisement Delivery Table” having a list of localities with the value of their predicted “ClickCounts”. We initialise “TotalAds” field to “MaxAdsPerHour” for all entries.

### c) Advertisement Delivery Method

The advertisements to be broadcast to localities are scheduled at the start of the current hour. Let the Content Service Provider have “AdvertisementsCount” number of advertisements in a specific advertising domain to be broadcast in the current hour (FIG. 16).

From the last section it can be observed that the entries in “Advertisement Delivery Table” have been sorted as per the preferences of localities for the advertisement in specific advertisement domains. We start from the top entry in the “Advertisement Delivery Table” for the domain of the advertisement. A maximum of “TotalAds” are scheduled for broadcast to the “Locality” in the entry. Then the pending advertisements are scheduled to be broadcast in the “Locality” of the next entry. The process continues till all “AdvertisementsCount” advertisements have been scheduled.

Advertisements are then broadcast to these selected localities in the current hour.

It should be noted the scope of present invention is not limited to mobile advertising. The concepts presented can also be utilised in other forms of advertising, like sending email based promotions to online computer users, online advertisements . . . etc.

It will be appreciated that embodiments of the invention described herein (especially the prediction and delivery system) may be comprises of one or more conventional processors and unique stored program instructions that control the one or more processors to implement, in conjunction with certain non-processor circuits, some, most, or all of the prediction functions described herein. Alternatively, some or all of the prediction functions could be implemented by a state machine that has no stored program instructions or in one or more application specific integrated circuits (ASICs), in which each function or some combinations of certain of the functions are implemented as custom logic.

Of course, a combination of the two approaches could be used. Thus, method and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The advantages of the disclosed invention are thus attained in an economical, practical, and facile manner. While preferred aspects and example configurations have been shown and described, it is to be understood that various further modifications and additional configurations will be apparent to those skilled in the art. It is intended that the specific embodiments and configurations herein disclosed are illustrative of the invention, and should not be interpreted as limitations on the scope of the invention.

1. A method for predicting specific mobile users for targeting advertisements, the said method comprising:
selecting at least one subset of mobile users subscribing to number of mobile services;
creating and initializing subscribers attribute list and subscriber prediction table, based on their demographic details;
monitoring the response & behavioral pattern of the mobile users of the subset based on the advertisements sent randomly throughout the day;
populating the attribute list and prediction table based on the response information received from the mobile users;
formulating a prediction-delivery matrix to identify the preferences of the mobile users for serving advertisements based on the populated attribute list & prediction table;
generating a preference information of the mobile users of the subset based on the formulated matrix;
extrapolating the generated preference information to the rest of the mobile user subscribers; and
mining the mobile users data based on the extrapolated preference information for identifying specific user group for transmitting an advertisement.

2. The method as claimed in claim 1, wherein said selecting at least one subset of subscribers is based on their subscription to value added services.

3. The method as claimed in claim 2, wherein said value added services can be delivered to a mobile terminal through a WAP portal, message services, voice portal, and other modes of mobile VAS delivery.

4. The method as claimed in claim 1, further comprising predicting the time slots for sending advertisements during which the subscribers have highest probability of accepting advertisements.

5. The method as claimed in claim 1, further comprising determining a threshold level for transmitting advertisements to each of the subscribers per day.

6. The method as claimed in claims 4 and 5, further comprising scheduling and controlling the delivery of the advertisements to be sent to a subscriber's mobile terminal based on the determination of the time slots and the threshold level for ensuring highest probability of acceptance and fair distribution of advertisements.

7. The method as claimed in claim 1, further comprising:
determining the keywords in the content being displayed on the WAP Portal and determining keywords related to advertisement domains; and
mapping the relevant advertisements to the content.

8. The method as claimed in claim 7, further comprising
predicting the advertisement acceptance probability of subscribers accessing a WAP portal based on their actions and content being viewed by them; and
displaying them the most relevant and right number of advertisements to get a high response.

9. The method as claimed in claim 1, further comprising predicting the subscribers for high preference for advertisements in new advertising domains, for which no previous records are available.

10. A method for predicting specific set of localities for targeting broadcast mobile advertisements, the said method comprising:
selecting at least one subset of localities, having residents subscribing to number of mobile services;
creating and initializing subscribers attribute list and localities prediction table for this subset of localities, based on the demographic distribution of subscribers in these localities and the VAS services subscribed by them;
monitoring the behavioral pattern of the mobile users of the subset of localities and their responses to advertisements broadcast through cell towers of these localities randomly throughout the day, where a broadcast advertisement is received by all the subscribers in the locality;
populating the attribute list and prediction table based on the behavioral pattern and advertisement responses received from the mobile users;
formulating a prediction-delivery matrix to identify the preferences of the mobile users population in the localities for broadcasting advertisements based on the populated attribute list & prediction table;
generating a preference information of the mobile users of the subset of the locality based on the formulated matrix;
extrapolating the generated preference information to the rest of the rest of the localities; and
mining the mobile users data of the localities based on the extrapolated preference information for identifying specific localities for broadcasting the advertisements.

11. The method as claimed in claim 10, further comprising categorizing the subscribers profiles in the localities into one or more of the following categories
static profile;
dynamic profile; and
real time profile.

12. The method as claimed in claim 11, wherein the said step of categorizing is based on the real time information on the physical movement of the subscribers in a particular locality.

13. The method as claimed in claims 11 and 12, wherein the said step of categorizing is performed by identifying that the subscribers in a particular locality are residents or visitors in the said locality.

14. The method as claimed in claim 10, wherein said selecting at least one subset of localities is based on subscription of value added services by subscribers in the locality.

15. The method as claimed in claim 14, wherein said value added services can be delivered to a mobile terminal through broadcast messages.

16. The method as claimed in claim 10, further comprising
predicting the time slots for broadcasting advertisements during which the subscribers in the selected localities have highest probability of accepting advertisements.

17. The method as claimed in claim 10, further comprising
determining a threshold level for broadcasting advertisements to each locality per hour of the day.

18. The method as claimed in claims 10, 16 and 17, further comprising
scheduling and controlling the delivery of the advertisements to be broadcast in subset of localities based on the prediction of the time slots ensuring highest probability of acceptance and at the threshold level ensuring fair distribution of advertisements.

19. A system for predicting specific mobile user group for targeting advertisements, the said system comprising:
a transceiver for transmitting advertisements randomly to a subset of mobile users with specific demographic attributes and subscribing to a number of mobile services;
an advertisement allocation unit for scheduling and controlling the timeslots for ads delivery and fair distribution amongst the subset of mobile users;
a response monitoring unit for monitoring the response & behavioral pattern of the mobile users of the subset based on the advertisements sent randomly through out the day;
a data repository for storing a subscriber attribute list & prediction table;
and
a prediction server coupled to the said response detection unit and advertisement allocation unit, the said comprising:
a means for formulating a prediction-delivery matrix to identify the preferences of the mobile users for serving advertisements based on populating a subscriber attribute list & prediction table;
a means for generating a preference information of the mobile users of the subset based on the formulated matrix;
a means for extrapolating the generated preference information to the rest of the mobile users; and
a means for mining the mobile users data based on the extrapolated preference information for identifying specific user group for transmitting an advertisement.

20. The system as claimed in claim 19, wherein the said response monitoring unit comprising:
a receiver circuit operable to receive response information of a user for a particular advertisements.

21. The system as claimed in claim 19, wherein the said advertisement allocation unit comprising:
a memory for storing the received response information;
a threshold level generator for determining the number of advertisements to be sent to the mobile users based on the received response information; and
an advertisement timing controller for predicting the time slots for sending advertisements during which the subscribers have highest probability of accepting advertisements and controlling the transmission of the advertisements.

22. The system as claimed in claim 19, wherein the said prediction server comprising:
an interface unit;
a memory;
an extraction circuit configured to compute the response information received; and
a processing circuit for classifying the reaction of a mobile user to the advertisement based on the response information by creating prediction-delivery matrix, generating preference summaries and extrapolating the generated preference summaries of the mobile users of the subset to the rest of the subscribers for identifying specific user group for transmitting an advertisement.

23. The system as claimed in claim 17, further comprising: advertisement broadcasting circuit for broadcasting the selected advertisements to the specific localities.

24. The system as claimed in claim 19, wherein the said prediction server being configured to select at least one subset of mobile users subscribing to number of mobile services.

25. The system as claimed in claim 24, wherein the said prediction server being configured to select at least one subset of subscribers based on their subscription to value added services.

26. The system as claimed in claims 19 and 25, wherein the said transmitter being configured to transmit the said value added services to a mobile terminal through a WAP portal, message services, voice portal, and other modes of mobile VAS delivery.

27. The system as claimed in claim 22, wherein the said prediction server is further configured to:
determine the keywords in the content being displayed on the WAP Portal and determining keywords related to advertisement domains; and
mapping the relevant advertisements to the content.

28. The system as claimed in claim 22, wherein the said prediction server is further configured to:
predicting the advertisement acceptance probability of subscribers accessing a WAP portal based on their actions and content being viewed by them; and
displaying them the most relevant and right number of advertisements to get a high response.

29. The system as claimed in claim 22, wherein the said prediction server is further configured to predict the subscribers for high preference for advertisements in new advertising domains, for which no previous records are available.

30. A system for predicting specific set of localities for targeting broadcast mobile advertisements, the said system comprising:
a transceiver for transmitting advertisements randomly to at least to a selected subset of localities, which has residents subscribing to number of mobile services having a specific demographic attributes;
an advertisement allocation unit for scheduling and controlling the timeslots for ads delivery and fair distribution amongst the subset of mobile users present in the selected locality;
a response monitoring unit for monitoring the response & behavioral pattern of the mobile users of the subset of the localities based on the advertisements sent randomly through out the day;
a data repository for storing a subscriber attribute list & prediction table;
and
a prediction server coupled to the said response detection unit and advertisement allocation unit, the said comprising:
means for populating the attribute list and prediction table based on the behavioral pattern and advertisement responses received from the mobile users;
means for formulating a prediction-delivery matrix to identify the preferences of the mobile users population in the localities for broadcasting advertisements based on the populated attribute list & prediction table;
means for generating a preference information of the mobile users of the subset of the locality based on the formulated matrix;
means for extrapolating the generated preference information to the rest of the rest of the localities; and
mining the mobile users data of the localities based on the extrapolated preference information for identifying specific localities for broadcasting the advertisements.

31. The system as claimed in claim 30, wherein the said response monitoring unit comprising:
a receiver circuit operable to receive response information of the mobile user of a locality for a particular advertisement.

32. The system as claimed in claim 31, wherein the said advertisement allocation unit comprising:
a memory for storing the received response information;
a threshold level generator for determining the number of advertisements to be sent to the mobile users of the subset of the localities based on the received response information; and
an advertisement timing controller for predicting the time slots for sending advertisements during which the subscribers of the subset of the localities have highest probability of accepting advertisements and controlling the transmission of the advertisements.

33. The system as claimed in claim 30, wherein the said prediction server comprising:
an interface unit;
a memory;
an extraction circuit configured to compute the response information received; and
a processing circuit for classifying the reaction of a mobile user of the subset of the localities to the advertisement based on the response information by creating prediction-delivery matrix, generating preference summaries and extrapolating the generated preference summaries of the mobile users of the subset of the localities to the rest of the localities for identifying specific user group for transmitting an advertisement.

34. The system as claimed in claim 30, further comprising: advertisement broadcasting circuit for broadcasting the selected advertisements to the specific localities.

35. The system as claimed in claim 30, the said prediction server configured to categorize the subscribers profiles in the localities into one or more of the following categories
static profile;
dynamic profile; and
real time profile.

36. The system as claimed in claim 35, the said prediction server is configured to categorize based on the real time information on the physical movement of the subscribers in a particular locality.

37. The system as claimed in claims 35 and 36, the said prediction server performs the categorization by identifying that the subscribers in a particular locality are residents or visitors in the said locality.

38. The system as claimed in claim 30, wherein the prediction server selects at least one subset of localities, based on subscription of value added services by subscribers in the locality.

39. The system as claimed in claims 34 and 38, wherein said broadcasting circuit broadcast the value added services to a mobile terminal.

40. An advertisement delivery server for predicting specific mobile user group for targeting advertisements, the said server comprising:
a memory; and
a processor operationally coupled to the said memory configured for:
selecting at least one subset of mobile users subscribing to number of mobile services;
creating and initializing subscribers attribute list and subscriber prediction table, based on their demographic details;
monitoring the response & behavioral pattern of the mobile users of the subset based on the advertisements sent randomly throughout the day;
populating the attribute list and prediction table based on the feedback received from the mobile users;
formulating a prediction-delivery matrix to identify the preferences of the mobile users for serving advertisements based on the populated attribute list & prediction table;
mapping the prediction-delivery matrix to the rest of the mobile users; and
mining the mobile users data based on the mapping and generating preference summaries for identifying specific user group for transmitting an advertisement.

41. An advertisement delivery server for predicting specific set of localities for targeting broadcast mobile advertisements, the said server comprising:
a memory; and
a processor operationally coupled to the said memory configured for:
selecting at least one subset of localities, which has residents subscribing to number of mobile services;
creating and initializing subscribers attribute list and localities prediction table for this subset of localities, based on the demographic distribution of subscribers in these localities and the VAS services subscribed by them;
monitoring the behavioral pattern of the mobile users of the subset of localities and their responses to advertisements broadcast through cell towers of these localities randomly throughout the day, where a broadcast advertisement is received by all the subscribers in the locality;
populating the attribute list and prediction table based on the behavioral pattern and advertisement responses received from the mobile users;
formulating a prediction-delivery matrix to identify the preferences of the mobile users population in the localities for broadcasting advertisements based on the populated attribute list & prediction table;
generating a preference information of the mobile users of the subset of the locality based on the formulated matrix;
extrapolating the generated preference information to the rest of the rest of the localities; and
mining the mobile users data of the localities based on the extrapolated preference information for identifying specific localities for broadcasting the advertisements.

42. A computer program product comprising:
program instructions operable to perform a process in a computing device, the process comprising:
selecting at least one subset of mobile users subscribing to number of mobile services;
creating and initializing subscribers attribute list and subscriber prediction table, based on their demographic details;
monitoring the response & behavioral pattern of the mobile users of the subset based on the advertisements sent randomly throughout the day;
populating the attribute list and prediction table based on the response information received from the mobile users;
formulating a prediction-delivery matrix to identify the preferences of the mobile users for serving advertisements based on the populated attribute list & prediction table;
generating a preference information of the mobile users of the subset based on the formulated matrix;
extrapolating the generated preference information to the rest of the mobile user subscribers; and
mining the mobile users data based on the extrapolated preference information for identifying specific user group for transmitting an advertisement.

43. A computer program product comprising:
program instructions operable to perform a process in a computing device, the process comprising:
selecting at least one subset of localities, which has residents subscribing to number of mobile services;
creating and initializing subscribers attribute list and localities prediction table for this subset of localities, based on the demographic distribution of subscribers in these localities and the VAS services subscribed by them;
monitoring the behavioral pattern of the mobile users of the subset of localities and their responses to advertisements broadcast through cell towers of these localities randomly throughout the day, where a broadcast advertisement is received by all the subscribers in the locality;
populating the attribute list and prediction table based on the behavioral pattern and advertisement responses received from the mobile users;
formulating a prediction-delivery matrix to identify the preferences of the mobile users population in the localities for broadcasting advertisements based on the populated attribute list & prediction table;
generating a preference information of the mobile users of the subset of the locality based on the formulated matrix;
extrapolating the generated preference information to the rest of the rest of the localities; and
mining the mobile users data of the localities based on the extrapolated preference information for identifying specific localities for broadcasting the advertisements.
